(19) United States
(12) Patent Application Publication
(10) Pub. No.: US 2026/0014795 A1
(43) Pub. Date: Jan. 15, 2026

(54) PRINTING APPARATUS

(71) Applicant: CANON KABUSHIKI KAISHA, Tokyo (JP)

(72) Inventors: TETSUYO OHASHI, Kanagawa (JP); MINEYOSHI TOMIE, Saitama (JP); YURI MORI, Tokyo (JP); TAICHI WATANABE, Kanagawa (JP)

(21) Appl. No.: 19/260,049

(22) Filed: Jul. 3, 2025

(30) Foreign Application Priority Data
Jul. 12, 2024 (JP) 2024-112649
Apr. 21, 2025 (JP) 2025-069899

(51) Int. Cl. B41J 2/175; B41J 29/46

(52) U.S. Cl. CPC B41J 2/175; B41J 29/46

(57) ABSTRACT

A printing apparatus includes a forming unit configured to form a liquid chamber to which a liquid is introduced and which stores the liquid, and a pressure chamber, a wall member configured to partition between the liquid chamber and the pressure chamber and be displaced in accordance with a pressure in the pressure chamber, a pressure adjusting unit configured to adjust the pressure in the pressure chamber so as to perform a replenishing operation of introducing the liquid from a liquid container to the liquid chamber, and a supplying operation of supplying the liquid from the liquid chamber to a discharging unit, and an air release unit configured to release the pressure chamber to air in accordance with an operation associated with exchange of the liquid container during the replenishing operation but not to release the pressure chamber to the air during the supplying operation.

### BACKGROUND

### Field of the Technology

The present disclosure relates to a printing apparatus.

### Description of the Related Art

A printing apparatus that prints an image by discharging ink from a discharge head is configured to be able to exchange a container that stores the ink. When exchanging the container, the stored ink may leak, and there is also proposed a printing apparatus with a measure against this (for example, Japanese Patent Laid-Open No. 2006-192793).

In a printing apparatus with an intermediate liquid chamber provided between a discharge head and a container storing ink, it is possible to increase/decrease the capacity of the liquid chamber by controlling the pressure around the liquid chamber, thereby introducing the ink to the liquid chamber and pressurizing and supplying the ink from the liquid chamber to the discharge head. In the printing apparatus having this configuration, if the container is exchanged during ink introduction to the liquid chamber, bubbles may be sucked into the channel of the ink. On the other hand, if pressure control is uniformly stopped in a case where the container is exchanged, the printing operation need be stopped in some cases in exchange of the container during pressurization and supply, and productivity may lower.

### SUMMARY

The present disclosure provides a technique of enabling to prevent bubbles from being mixed into a channel or productivity from lowering in a case where a container is exchanged.

According to one aspect of the present disclosure, there is provided a printing apparatus comprising: a forming unit configured to form a liquid chamber to which a liquid is introduced from a liquid container and which stores the liquid to be supplied to a discharging unit configured to discharge the liquid to a print medium, and a pressure chamber adjacent to the liquid chamber; a wall member configured to partition between the liquid chamber and the pressure chamber and be displaced in accordance with a pressure in the pressure chamber so as to change a capacity of the liquid chamber; a pressure adjusting unit configured to adjust the pressure in the pressure chamber so as to perform a replenishing operation of introducing the liquid from the liquid container to the liquid chamber, and a supplying operation of supplying the liquid from the liquid chamber to the discharging unit; and an air release unit configured to release the pressure chamber to air in accordance with an operation associated with exchange of the liquid container during the replenishing operation but not to release the pressure chamber to the air for the operation during the supplying operation.

Features of the present disclosure will become apparent from the following description of embodiments with reference to the attached drawings. The following description of embodiments are described by way of example.

### BRIEF DESCRIPTION OF THE DRAWINGS

FIG. 1A is a view showing the outer appearance of a printing apparatus according to the embodiment of the present disclosure;

FIG. 1B is a view showing a state in which an access cover is opened;

FIG. 2 is an explanatory view of the internal mechanism of the printing apparatus shown in FIG. 1A;

FIG. 3 is an explanatory view of a supplying unit for a liquid from a container to a discharge head;

FIG. 4 is an explanatory view showing the structure of an intermediate tank;

FIG. 5 is an explanatory view of the operation of the intermediate tank;

FIG. 6 is an explanatory view of the operation of the intermediate tank;

FIG. 7 is an explanatory view of the remaining amount detection operation in the intermediate tank;

FIG. 8 is an explanatory view of remaining amount determination concerning the intermediate tank;

FIG. 9 is an explanatory view showing the structures of check valves on the upstream and downstream sides of the intermediate tank;

FIG. 10 is an explanatory view of the structure and operation of a negative pressure maintaining unit;

FIG. 11 is an explanatory view of a pressure adjusting unit;

FIG. 12 is a view showing the open/close patterns of the control valves of the pressure adjusting unit;

FIG. 13 is an explanatory view of the operation of each control valve of the pressure adjusting unit;

FIG. 14 is a view showing a detailed example of the structure of the pressure adjusting unit;

FIG. 15 is an explanatory view of the structure of a valve unit;

FIG. 16 is a perspective view of a valve rubber;

FIG. 17A is an explanatory view of an air release unit;

FIG. 17B is an explanatory view of the operation of an interlocking valve;

FIG. 18 is an explanatory view of the operation of the air release unit;

FIG. 19 is a block diagram of the control circuit of the supplying unit shown in FIG. 3;

FIG. 20 is a flowchart showing an example of processing of the control circuit;

FIG. 21 is a flowchart showing an example of processing of the control circuit;

FIG. 22 is a flowchart showing an example of processing of the control circuit;

FIGS. 23A and 23B show a flowchart showing an example of processing of the control circuit;

FIG. 24 is a flowchart showing an example of processing of the control circuit;

FIG. 25 is a block diagram of another example of the control circuit;

FIG. 26 is a flowchart showing an example of processing of the control circuit; and

FIG. 27 is a flowchart showing an example of processing of the control circuit.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Outline of Printing Apparatus

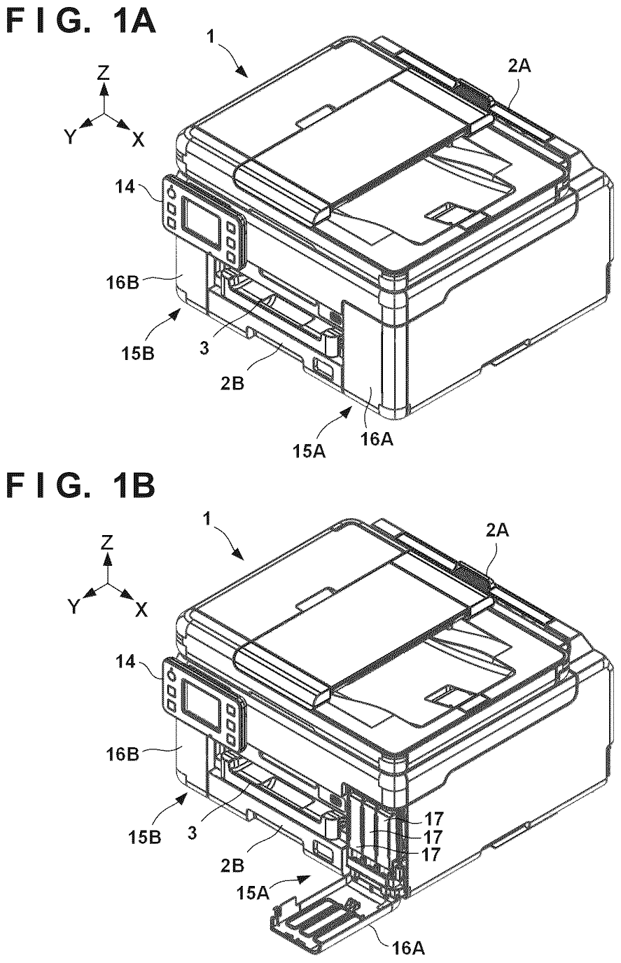

FIG. 1A is a view showing the outer appearance of a printing apparatus 1 according to the embodiment of the present disclosure, which is viewed from the front side. The printing apparatus 1 according to this embodiment is an inkjet printing apparatus that discharges ink that is a liquid and thus performs printing on a print medium. In the drawings, arrows X to Z indicate directions crossing each other. Particularly, in this embodiment, the arrows X and Y indicate horizontal directions crossing each other, and the arrow Z indicates the up/down direction (gravity direction). The X direction is the widthwise direction (left/right direction) of the printing apparatus 1. The Y direction is the depth direction of the printing apparatus 1.

Note that “print” includes not only forming significant information such as characters and graphics but also forming images, figures, patterns, and the like on print media in a broad sense, or processing media, regardless of whether the information is significant or insignificant or whether the information is visualized so that a human can visually perceive it. In addition, although in this embodiment, sheet-like paper is assumed as a “print medium”, cloth, a plastic film, and the like may also be used.

The printing apparatus 1 has a rectangular parallelepiped shape as a whole. A folding-type paper feed tray 2A is provided on the rear portion of the upper surface, and a paper feed cassette 2B and a discharge port 3 are provided on the front surface portion. The paper feed tray 2A and the paper feed cassette 2B each form a stacking portion on which a print medium before printing is stacked. The paper feed cassette 2B can be inserted/removed in the Y direction with respect to the apparatus main body. The print medium after printing is discharged from the discharge port 3. The discharge port 3 is provided with a discharge tray on which the print medium after printing is placed.

An operation unit 14 that a user can operate is provided on the front surface portion of the printing apparatus 1. A display unit for displaying information and a plurality of operation buttons are provided on the operation unit 14, and the operation unit 14 can accept a user instruction input and present information to the user. The display unit may be a touch panel.

Storage units 15A and 15B are provided on the front portion of the printing apparatus 1. The storage units 15A and 15B are arranged apart in the X direction, and the paper feed cassette 2B and the discharge port 3 are provided between the storage units 15A and 15B. The storage units 15A and 15B are provided with access covers 16A and 16B that open/close the storage units 15A and 15B. When the access covers 16A and 16B are opened, the inside portions of the storage units 15A and 15B are exposed.

FIG. 1B shows a state in which the access cover 16A is opened. A plurality of containers 17 are stored in the storage unit 15A, and when the access cover 16A is opened, the containers 17 are exposed. The container 17 is a liquid container that stores ink as a liquid. The container 17 may have a form of a rigid box made of a resin or may have a form of a flexible bag (pack). When the access cover 16A is closed, the containers 17 are covered with the access cover 16A.

Each container 17 forms a cartridge-type ink tank that can be inserted/removed in the Y direction. The user can open the access cover 16A and exchange the containers 17. In this embodiment, the storage unit 15A stores three containers 17. Inks of different types are stored in the three containers 17. For example, the three containers 17 store yellow, magenta, and cyan inks.

The storage unit 15B and the access cover 16B are the same as the storage unit 15A and the access cover 16A. In this embodiment, however, one container 17 is stored in the storage unit 15B (not shown). The container 17 stored in the storage unit 15B stores, for example, black ink. In this embodiment, a form in which the storage units are provided on the left and right sides has been described. However, the containers 17 of four colors may be provided on one side, for example, at the position of the storage unit 15A.

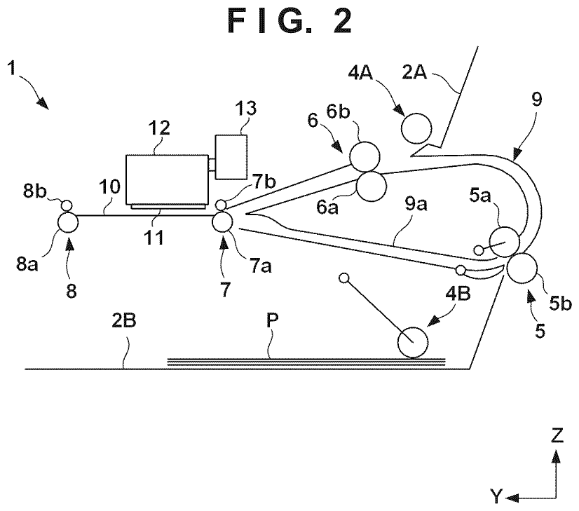

FIG. 2 is an explanatory view showing the internal mechanism of the printing apparatus 1. A print medium P set on the paper feed tray 2A or the paper feed cassette 2B is guided by a guide member 9 and thus conveyed by a conveyance unit 4A or 4B and conveyance units 5 to 8. During the process of conveyance, an image is printed by a discharge head 11, and the paper is discharged to the discharge port 3. The guide member 9 includes a guide portion 9a that forms a path for reversing the print medium P, and the printing apparatus 1 can also perform double-sided printing of the print medium P.

Of the conveyance units 4A and 4B and the conveyance units 5 to 8, the conveyance units 4A and 4B are arranged on the most upstream side in the conveyance direction of the print medium P. The conveyance unit 5 is arranged on the downstream side of the conveyance unit 4B, and the conveyance unit 6 is arranged on the downstream side of the conveyance unit 4A and the conveyance unit 5. The conveyance unit 7 is arranged on the downstream side of the conveyance unit 6, and the conveyance unit 8 is arranged on the downstream side of the conveyance unit 7.

The conveyance unit 7 conveys the print medium P in the Y direction (sub-scanning direction) with respect to the discharge head 11. The print position of the image in the Y direction on the print medium P is controlled by drive control of the conveyance unit 7. The conveyance unit 7 includes a driving roller 7a, and a driven roller 7b that is in pressure contact with the driving roller 7a, and the print medium P is clamped and conveyed by these rollers.

The conveyance units 4A and 4B and the conveyance units 5 and 6 can each also be called a feeding unit because these feed the print medium P to the conveyance unit 7. The conveyance units 4A and 4B according to this embodiment each include a pickup roller that picks up the print medium P from the corresponding paper feed tray 2A or paper feed cassette 2B and conveys it to the conveyance unit 5 or 6.

The conveyance units 5 and 6 include driving rollers 5a and 6a and driven rollers 5b and 6b in pressure contact with the corresponding driving rollers 5a and 6a, respectively, and the print medium P is clamped and conveyed by these rollers. The conveyance units 5 and 6 can each also be called an intermediate unit or intermediate roller because these are located between the conveyance units 4A and 4B on the most upstream side and the conveyance unit 7.

The conveyance unit 8 can also be called a discharging unit because it discharges the printed print medium P to the discharge port 3. The conveyance unit 8 includes a driving roller 8a and a driven roller 8b in pressure contact with the driving roller 8a, and the print medium P is clamped and conveyed by these rollers.

The discharge head 11 is a printhead that discharges ink and thus performs printing on a print medium. The discharge head 11 is located between the conveyance unit 7 and the conveyance unit 8 in the conveyance direction of the print medium P. The discharge head 11 is mounted on a carriage 12. The orifice surface (lower surface) of the discharge head 11 faces a platen 10, and a liquid is discharged from a plurality of nozzles formed in the ink discharge surface to the print medium P conveyed on the platen 10. The discharge head 11 is provided for each liquid type.

The carriage 12 is reciprocally moved by a driving unit 13 in a direction crossing the print medium P (in this embodiment, the X direction or the main scanning direction). The driving unit 13 is a belt transmission mechanism using a motor as a driving source, and includes, for example, a driving pulley and a driven pulley, which are apart in the X direction, an endless belt wound around these pulleys, and a guide member that guides the movement of the carriage 12 in the X direction. The carriage 12 is connected to the endless belt. When the driving pulley is rotated by the motor, the endless belt travels, and the carriage 12 moves. The discharge head 11 may exchangeably be attached to the carriage 12.

As described above, the printing apparatus 1 according to this embodiment is a serial type printing apparatus with the discharge head 11 mounted on the carriage 12. A printing operation for the print medium P is performed by alternately repeating a conveyance operation (intermittent conveyance operation) of conveying the print medium P by a predetermined amount by the conveyance unit 7 and print scanning during the stop of conveyance of the conveyance unit 7. Print scanning is an operation of discharging ink from the discharge head 11 while moving the carriage 12 with the discharge head 11 mounted thereon. Note that the discharge head 11 may be a full-line printhead extended in the X direction.

### Liquid Supplying System

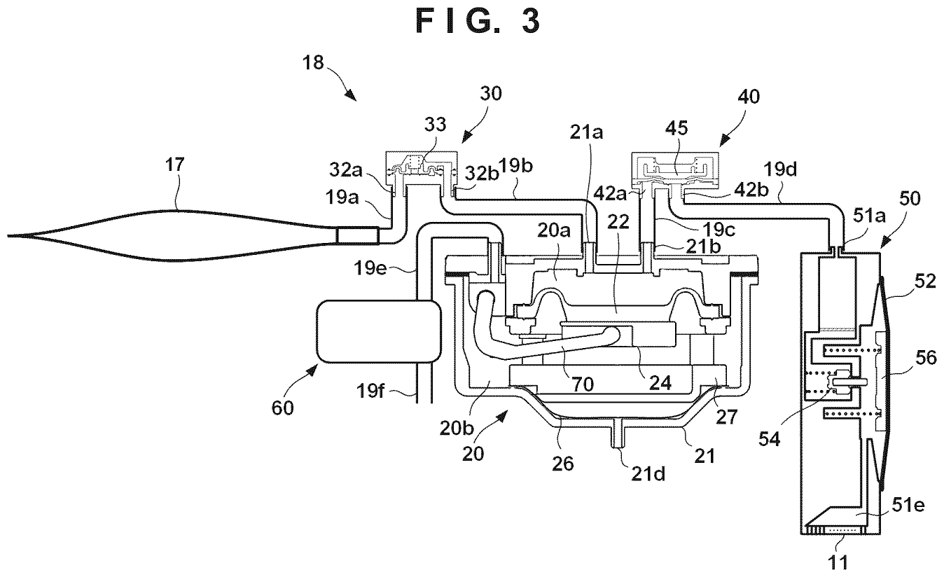

A supplying unit for a liquid from the container 17 to the discharge head 11, and the like will be described next. FIG. 3 is an explanatory view of a supplying unit 18.

The supplying unit 18 is a supplying mechanism that supplies a liquid from the container 17 to the discharge head 11. The supplying unit 18 is provided for each container 17. Hence, the printing apparatus 1 according to this embodiment includes four supplying units 18. FIG. 3 shows one of the four supplying units 18.

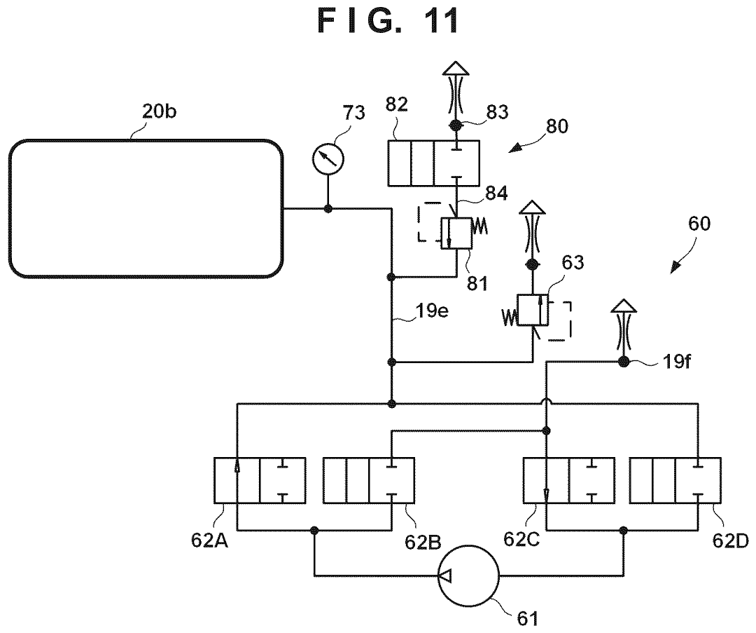

The supplying unit 18 includes an intermediate tank 20, check valves 30 and 40, a negative pressure maintaining unit 50, a pressure adjusting unit 60, and an air release unit 80 (FIG. 11). The intermediate tank 20 is connected to the container 17 via a pipe 19a, the check valve 30, and a pipe 19b. The negative pressure maintaining unit 50 is connected to the intermediate tank 20 via a pipe 19c, the check valve 40, and a pipe 19d.

The pressure adjusting unit 60 is connected to the intermediate tank 20 via a pipe 19e. The pipe 19e forms a channel of a fluid for pressure control. In this embodiment, the fluid is a gas and, particularly, air. A pipe 19f forms an air communicating path that communicates with the air. The air release unit 80 is connected to the intermediate tank 20 via the pipe 19e. The pipes 19a to 19f are each formed by, for example, a flexible tube. The pipes 19a to 19d may be made of a material whose gas permeability or water vapor permeability is low such that the quality of the liquid distributed inside is not changed. The pipes 19a to 19f may not always be flexible tubes, and a metal tube may be used at least partially, or a channel may be formed by closely adhering and sealing a component to a groove formed in a plate-shaped component.

The liquid in the container 17 is introduced into the intermediate tank 20 via the pipe 19a, the check valve 30, and the pipe 19b. The container 17 is located on the upstream side in the liquid introducing direction, and the intermediate tank 20 is located on the downstream side. The check valve 30 is a one-way valve (check valve) that is provided on the upstream side of the intermediate tank 20 and prevents the liquid from flowing backward from the side of the intermediate tank 20 to the side of the container 17.

The liquid in the intermediate tank 20 is supplied to the discharge head 11 via the pipe 19c, the check valve 40, the pipe 19d, and the negative pressure maintaining unit 50. The intermediate tank 20 is located on the upstream side in the liquid supplying direction, and the discharge head 11 is located on the downstream side. The check valve 40 is a one-way valve (check valve) that is provided on the downstream side of the intermediate tank 20 and prevents the liquid from flowing backward from the side of the negative pressure maintaining unit 50 to the side of the intermediate tank 20.

In this embodiment, replenishment of the liquid from the container 17 to the intermediate tank 20 is done using a pressure generated by the pressure adjusting unit 60. Hence, making the liquid pressure in the container 17 close to the atmospheric pressure suffices, and there are little restrictions of layout. Also, since liquid supply to the discharge head 11 is performed using a pressurization method, there are little restrictions concerning the installation place of each component, and installation in a place where a head difference exists between the intermediate tank 20 and the discharge head 11 is also possible.

### Intermediate Tank

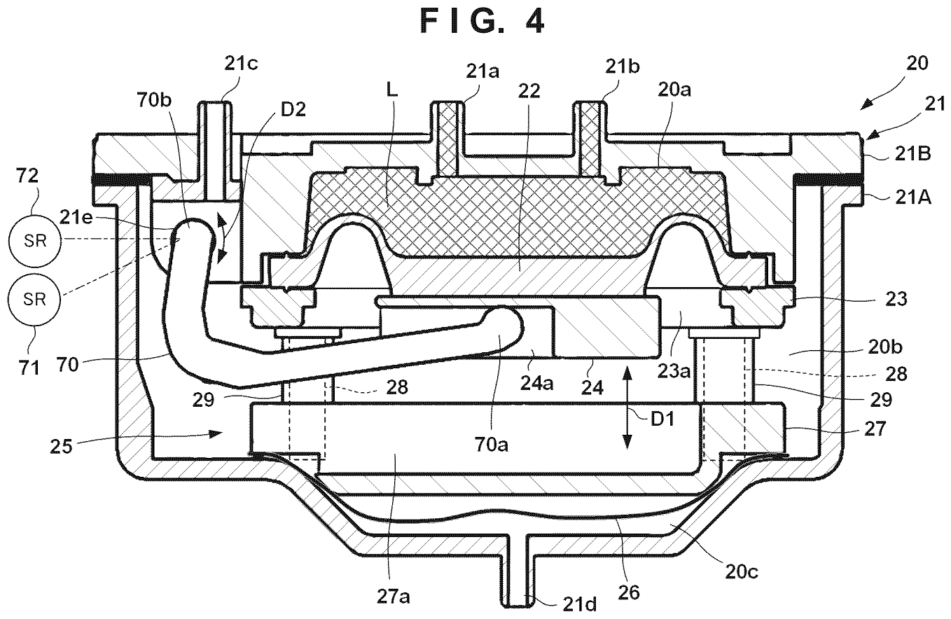

The configuration of the intermediate tank 20 will be described with reference to FIGS. 3 and 4. FIG. 4 is an explanatory view showing the structure of the intermediate tank 20. The intermediate tank 20 performs an introducing operation of introducing the liquid stored in the container 17 by suction and a supplying operation of supplying the introduced liquid to the discharge head 11. The introducing operation can also be called a liquid replenishing operation. In terms of the two operations, the intermediate tank 20 plays a role of a pump.

The intermediate tank 20 includes a forming unit 21 that forms a liquid chamber 20a and a pressure chamber 20b. The forming unit 21 is a hollow member that forms an outer wall defining the liquid chamber 20a and the pressure chamber 20b. In this embodiment, the forming unit 21 includes a housing 21A having a cup shape, and a lid member 21B that closes an opening in the top portion of the housing 21A.

The liquid chamber 20a stores a liquid L to be supplied to the discharge head 11. The liquid L is introduced from the container 17 into the liquid chamber 20a. The lid member 21B includes an inflow pipe 21a that forms an inlet communicating with the liquid chamber 20a, and an outflow pipe 21b that forms an outlet communicating with the liquid chamber 20a. The pipe 19b is connected to the inflow pipe 21a, and the pipe 19c is connected to the outflow pipe 21b.

The pressure chamber 20b is formed to be adjacent to the liquid chamber 20a via a wall member 22. The wall member 22 partitions between the liquid chamber 20a and the pressure chamber 20b. It can also be said that the wall member 22 is a part of a peripheral wall defining the liquid chamber 20a or the pressure chamber 20b. The wall member 22 is a diaphragm that is displaced in accordance with the pressure in the pressure chamber 20b, thereby changing the capacity of the liquid chamber 20a. The wall member 22 according to this embodiment is formed by a flexible sheet that is elastically deformed in accordance with the pressure difference between the liquid chamber 20a and the pressure chamber 20b, and has, on the peripheral edge portion, a convex-shaped portion formed into an annular shape.

The wall member 22 is hermetically sandwiched between the lid member 21B and a frame member 23. The frame member 23 is an annular member with an opening portion 23a at the central portion. The frame member 23 is supported by a plurality of shaft members 28 standing on the bottom portion of the housing 21A. The wall member 22 has its peripheral edge sandwiched between the lid member 21B and the frame member 23, and the central portion of the wall member 22 can be displaced to the lower side of the opening portion 23a.

The housing 21A includes a communicating pipe 21c that forms a communicating path communicating with the pressure adjusting unit 60 and the pressure chamber 20b. The pipe 19e is connected to the communicating pipe 21c. The pressure chamber 20b is provided with a restricting unit 25 that restricts the displacement of the wall member 22 in accordance with the pressure in the pressure chamber 20b. The restricting unit 25 restricts the maximum displacement position of the wall member 22 in the direction of expanding the liquid chamber 20a.

The restricting unit 25 includes a stopper 27 and a flexible member 26. The flexible member 26 forms, in the pressure chamber 20b, a partition wall to an air chamber 20c. In other words, the pressure chamber 20b is partitioned by the flexible member 26 into the portion of the air chamber 20c on the bottom side and a portion on the side of the liquid chamber 20a. The flexible member 26 is a diaphragm that is displaced in accordance with the pressure in the pressure chamber 20b, thereby changing the capacity of the air chamber 20c. The wall member 22 according to this embodiment is formed by a flexible film that is elastically deformed in accordance with the pressure difference between the liquid chamber 20a and the pressure chamber 20b, and its peripheral edge is hermetically fixed to the bottom portion of the housing 21A.

The housing 21A has, in its bottom portion, a communicating pipe 21d that forms an air communicating port. The communicating pipe 21d is always released, and the air chamber 20c is maintained at the atmospheric pressure. The stopper 27 is an elevating member that includes holes (not shown) for receiving the shaft members 28, is provided to freely move up/down in a direction D1 (the depth direction of the housing 21A) along the shaft members 28 serving as guide shafts, and is displaced by displacement of the flexible member 26. In this embodiment, the flexible member 26 is arranged between the stopper 27 and the bottom portion of the housing 21A. If the pressure chamber 20b is set in a negative pressure state, the flexible member 26 is displaced to the upper side, thereby increasing the capacity of the air chamber 20c. The stopper 27 thus rises to a restricting position to restrict the maximum displacement position. The stopper 27 includes a concave portion 27a in which an abutment member 24 enters.

The abutment member 24 is fixed to the central portion lower surface of the wall member 22. The abutment member 24 is displaced along with the displacement of the wall member 22. The abutment member 24 includes an engaging groove 24a with which an end portion 70a of a detection lever 70 engages. In this embodiment, the abutment member 24 abuts against the stopper 27, thereby restricting the displacement range of the wall member 22. It is also possible to employ a configuration in which the wall member 22 and the flexible member 26 are made to directly abut against each other to restrict the displacement range of the wall member 22. However, with the intervention of the abutment member 24 or the stopper 27, it is possible to prevent degradation of the wall member 22 and the flexible member 26 and more correctly restrict the displacement range.

A plurality of elastic members 29 are provided between the abutment member 24 and the stopper 27. The elastic member 29 according to this embodiment is a coil spring in which the shaft member 28 is inserted, and biases the abutment member 24 and the stopper 27 in a direction of separating these. In the state shown in FIG. 4, the abutment member 24 and the stopper 27 are apart, and the displacement range of the wall member 22 is not restricted.

The detection lever 70 is a movable member configured to detect the remaining amount of the liquid in the liquid chamber 20a. An intermediate portion 70b of the detection lever 70 passes through a shaft hole 21e and is rotatably supported by the shaft hole 21e. Depending on the remaining amount of the liquid in the liquid chamber 20a, the abutment member 24 is displaced in the direction D1. The detection lever 70 rotates in a direction D2 along with the displacement of the abutment member 24. The rotation amount of the detection lever 70 is detected by remaining amount detection sensors 71 and 72 arranged inside the housing 21A. The remaining amount of the liquid in the liquid chamber 20a can be estimated based on the detection results of the remaining amount detection sensors 71 and 72. Note that the detection lever 70 is always biased counterclockwise in FIG. 4 by an elastic member (not shown). Also, the intermediate portion 70b of the detection lever 70 may pass through the shaft hole 21e formed in the housing 21A and extend to the outside of the housing 21A. In this case, the intermediate portion 70b may rotatably be supported by the shaft hole 21e that is hermetically sealed.

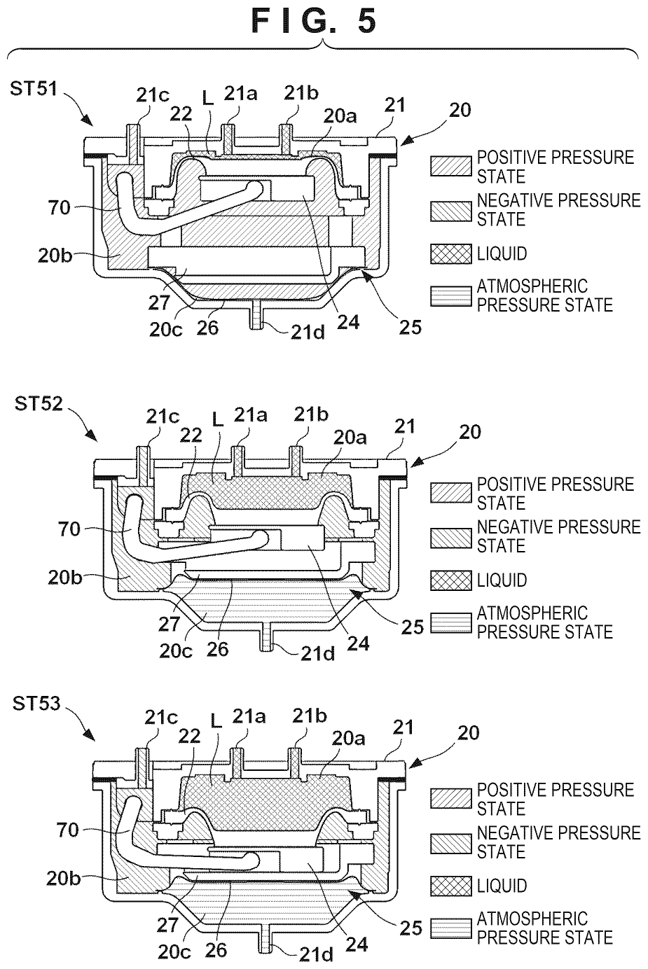

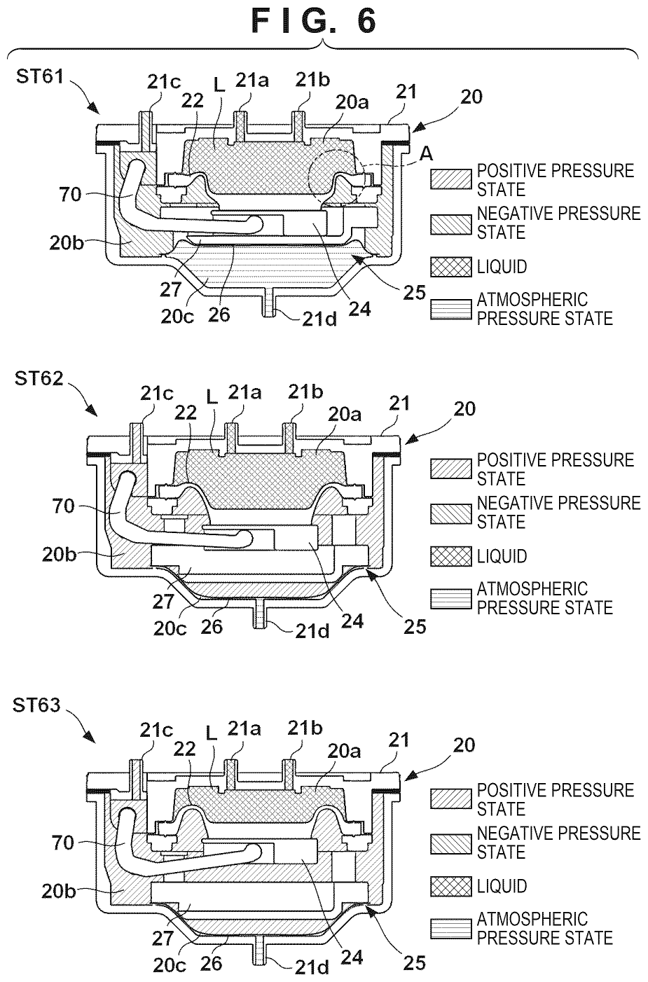

The operation of the intermediate tank 20 will be described with reference to FIGS. 5 and 6, in addition to FIG. 4. FIGS. 5 and 6 show the operation of each portion of the intermediate tank 20 together with the internal pressure state.

A state ST51 shown in FIG. 5 indicates a state in which the liquid L in the liquid chamber 20a nearly runs out by the supplying operation, and the capacity of the liquid chamber 20a is minimum. The pressure chamber 20b is set in a positive pressure state by the pressure adjusting unit 60. The capacity of the air chamber 20c is substantially zero, and the stopper 27 is located at a position closest to the bottom portion of the housing 21A. To the contrary, the abutment member 24 is located at a position closest to the liquid chamber 20a. The replenishing operation is performed from this state. Note that the replenishing operation may not always be performed after the remaining amount in the intermediate tank 20a decreases to the stage of the state ST51, and the replenishing operation may be performed when, for example, the remaining amount is about 50%.

A state ST52 in FIG. 5 indicates a stage in which the replenishing operation is started and the pressure chamber 20b is set in a negative pressure state by the pressure adjusting unit 60. Since the pressure chamber 20b is set to the negative pressure, the wall member 22 and the abutment member 24 are displaced to the side of the bottom portion of the housing 21A. The capacity of the liquid chamber 20a increases, and the liquid L is sucked from the container 17 into the liquid chamber 20a. In the state ST52, the liquid L about 50% of the maximum capacity of the liquid chamber 20a is introduced into the liquid chamber 20a.

In the state ST52 shown in FIG. 5, the flexible member 26 and the stopper 27 are displaced in the direction opposite to the wall member 22 (to the side of the lid member 21B), air is sucked into the air chamber 20c, and the capacity thereof increases. In this embodiment, if the pressure chamber 20b is set in the negative pressure state, the flexible member 26 is displaced before the wall member 22. It is a liquid with viscosity that flows into the liquid chamber 20a. On the other hand, it is air having a flow resistance lower than that of the liquid, which flows into the air chamber 20c. Also, the inner diameter or length of the communicating pipe 21d can be designed to provide little or no flow resistance. This makes it possible to quickly deform the flexible member 26. Thus, the displacement range of the wall member 22 can be restricted such that the flexible member 26 is displaced before the wall member 22.

The stopper 27 translates to the side of the liquid chamber 20a by the guidance of the plurality of shaft members 28. The stopper 27 moves against the biasing force of the elastic members 29. The stopper 27 moves until it abuts against projections (not shown) formed on the shaft members 28. That position is the restricting position for restricting the displacement range of the wall member 22. Note that the stopper 27 may be configured not to stop moving at a predetermined portion on the shaft member 28.

A state ST53 in FIG. 5 indicates a stage in which the liquid L further flows into the liquid chamber 20a. The pressure chamber 20b is continuously set in the negative pressure state, and the wall member 22 is displaced in the direction of increasing the capacity of the liquid chamber 20a and deformed to expand. The abutment member 24 abuts against the stopper 27, and the displacement of the wall member 22 is restricted.

Note that letting S1 and S2 be the projection areas of the wall member 22 and the flexible member 26 on a horizontal plane (a plane orthogonal to the direction D1 in FIG. 4), the shapes are designed such that
S1<S2
   holds. In a state in which the same negative pressure NP acts,
   |NP|×S1<|NP|×S2
   holds. The force of expanding the flexible member 26 is larger than the force of expanding the wall member 22. Hence, when the abutment member 24 abuts against the stopper 27, the displacement of the wall member 22 is reliably restricted.

A state ST61 in FIG. 6 indicates a state in which the negative pressure continuously acts on the wall member 22 from the state ST53 in FIG. 5. Since the abutment member 24 cannot further move to the side of the stopper 27 due to the restriction of the stopper 27, further elastic deformation occurs in a part (a thin portion like a portion A in FIG. 6) of the wall member 22. The deformation stops when the force of the negative pressure in the pressure chamber 20b and the elastic deformation force of the portion A of the wall member 22 balance. A slightly extra amount of liquid L flows into the liquid chamber 20a in correspondence with the deformation of the portion A. In other words, it can be said that the capacity of the liquid chamber 20a at the stage of the state ST61 is the maximum capacity in the replenishing operation, and the maximum capacity is limited by the restricting unit 25.

A state ST62 in FIG. 6 indicates a state in which the replenishing operation is ended, and the supplying operation is started. The negative pressure state of the pressure chamber 20b is canceled by the pressure adjusting unit 60, and the state changes to the positive pressure state via the atmospheric pressure. Air is exhausted from the air chamber 20c via the communicating pipe 21d, and the flexible member 26 is crushed and displaced to the side of the communicating pipe 21d. Along with the displacement of the flexible member 26, the stopper 27 is also displaced to the side of the communicating pipe 21d by the bias of the elastic members 29, and the restriction of the displacement range of the wall member 22 is canceled.

When the restriction of the displacement range of the wall member 22 is canceled, the constraint of the portion A of the wall member 22 indicated by the state ST61 is released, and it is going to restore the original form. Since the slightly extra amount of liquid L corresponding the deformation of the portion A already flows into the liquid chamber 20a, the abutment member 24 is displaced to the side of the stopper 27 in correspondence with the amount. As a result, the pressure in the liquid chamber 20a substantially equals the pressure in the pressure chamber 20b, and the elastic deformation force corresponding to the deformation of the portion A of the wall member 22 does not act when pressurizing the liquid L in the liquid chamber 20a and supplying it to the discharge head 11.

This point will be described in more detail. Assume a state in which the restricting unit 25 is not provided, the wall member 22 abuts against a portion (for example, the inner wall of the pressure chamber 20b) for which displacement restriction cannot be canceled in the replenishing operation, and elastic deformation further occurs in a part of the wall member 22, like the portion A. In this state, if the pressure chamber 20b is changed from the negative pressure state to the positive pressure state, the pressure of the liquid L in the liquid chamber 20a is increased by the restoring force of a partially elastically deformed portion, like the portion A of the wall member 22. As a result, the liquid L is supplied by a force stronger than a pressurizing force assumed for the control of the pressure adjusting unit 60, and the flow of the liquid L may be unstable on the side of the discharge head 11.

To the contrary, in this embodiment, when the pressure chamber 20b is in the negative pressure state, the displacement of the wall member 22 is restricted by the restricting unit 25. When the negative pressure state is canceled, the restriction of the displacement of the wall member 22 is also canceled, and the partial elastic deformation of the wall member 22 is canceled. It is therefore possible to prevent the pressure of the liquid L in the liquid chamber 20a from increasing due to the elastic deformation of a part of the wall member 22. For this reason, the supply pressure of the liquid L supplied from the liquid chamber 20a to the discharge head can be controlled more correctly by the pressure adjusting unit 60, and variations of the supply pressure can be reduced.

Note that if the excessive elastic deformation of a part of the wall member 22 is detected before it occurs, and the negative pressure in the pressure chamber 20b is canceled, the extra liquid L can be prevented from flowing into the liquid chamber 20a. However, it is not easy to detect the stage immediately before a part of the wall member 22 is excessively elastically deformed, and an additional sensor or the like may be used. On the other hand, this embodiment is advantageous in terms of cost and apparatus layout.

In the stage of the state ST62, the pressure state in the pressure chamber 20b is the positive pressure state, and the pressure of the liquid L in the liquid chamber 20a substantially equals the air pressure in the pressure chamber 20b. A state ST63 in FIG. 6 indicates a state in which the capacity of the liquid chamber 20a is reduced, and the liquid L is supplied from the liquid chamber 20a to the side of the discharge head 11. The state ST63 indicates a state in which the liquid L about 50% of the maximum capacity of the liquid chamber 20a is supplied to the side of the discharge head 11. Note that whether to actually supply the liquid depends on the state of the negative pressure maintaining unit 50, and this point will be described later. When the supply of the liquid L progresses, the state changes to the state ST51 shown in FIG. 5, and the same operation as described above is repeated.

### Detection of Remaining Amount

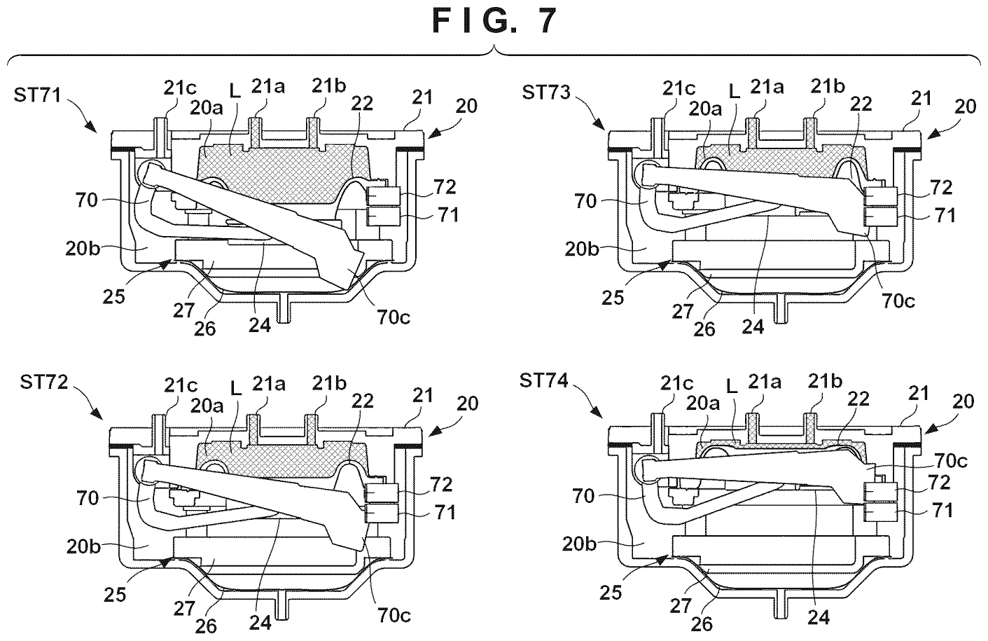

Detection of the remaining amount of the liquid L in the liquid chamber 20a will be described with reference to FIG. 7. FIG. 7 is an explanatory view of the remaining amount detection operation in the intermediate tank 20. As described above, rotation of the detection lever 70 is detected by the remaining amount detection sensors 71 and 72 arranged inside the housing 21A. FIG. 7 is a view obtained by adding the portions of the remaining amount detection sensors 71 and 72 and the detection lever 70 to the views of the operations of the internal components of the intermediate tank 20 shown in FIGS. 5 and 6 for easy understanding of the detection operation.

The detection lever 70 includes a detection piece 70c. The detection piece 70c is a portion inside the housing 21A. In this embodiment, each of the remaining amount detection sensors 71 and 72 is an optical sensor represented by a photo interrupter. The remaining amount detection sensors 71 and 72 are arranged at positions shifted on the rotation locus of the detection piece 70c, and the detection piece 70c functions as a shielding plate that shields the optical axes of the remaining amount detection sensors 71 and 72. The detection piece 70c may be a portion outside the housing 21A. In this case, a part of the detection lever 70 can be laid out outside the housing 21A, and the remaining amount detection sensors 71 and 72 can also be arranged outside the housing 21A. The wires of the remaining amount detection sensors 71 and 72 can be extended to the outside of the housing 21A by hermetically sealing these.

A state ST71 shown in FIG. 7 indicates a state in which the liquid L 100% of the maximum capacity is replenished to the liquid chamber 20a. In this state, the detection piece 70c is located at a position deviating from both the remaining amount detection sensors 71 and 72 and is not detected.

A state ST72 in FIG. 7 indicates a state in which the liquid L flows out from the liquid chamber 20a, and the remaining amount is 60% of the maximum capacity. In this state, the detection piece 70c is detected by the remaining amount detection sensor 71 but not by the remaining amount detection sensor 72.

A state ST73 in FIG. 7 indicates a state in which the liquid L further flows out from the liquid chamber 20a, and the remaining amount is 40% of the maximum capacity. In this state, the detection piece 70c is detected by both the remaining amount detection sensors 71 and 72.

A state ST74 in FIG. 7 indicates a state in which the liquid L further flows out from the liquid chamber 20a, and the remaining amount is not more than 10% of the maximum capacity. In this state, the detection piece 70c is detected not by the remaining amount detection sensor 71 but by the remaining amount detection sensor 72.

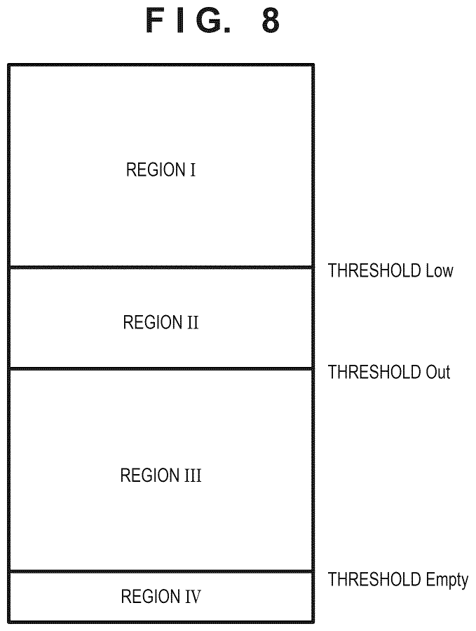

FIG. 8 is an explanatory view of remaining amount determination for the liquid L in the liquid chamber 20a. In this embodiment, the estimated remaining amount of the liquid L is divided into regions I to IV. The region I is a region corresponding to a remaining amount of 60% to 100%, the region II is a region corresponding to a remaining amount of 40% to 60%, the region III is a region corresponding to a remaining amount of 10% to 40%, and the region IV is a region corresponding to a remaining amount not more than 10%.

Each region is defined by a threshold corresponding to the rotation position of the detection lever 70. The regions I and II are discriminated by a threshold Low. The threshold Low corresponds to the rotation position of the detection lever 70 when the detection result of the remaining amount detection sensor 71 is “detection” and the detection result of the remaining amount detection sensor 72 is “non-detection”. The regions II and III are discriminated by a threshold Out. The threshold Out corresponds to the rotation position of the detection lever 70 when both the detection results of the remaining amount detection sensors 71 and 72 are “detection”. The regions III and IV are discriminated by a threshold Empty. The threshold Empty corresponds to the rotation position of the detection lever 70 when the detection result of the remaining amount detection sensor 71 is “non-detection” and the detection result of the remaining amount detection sensor 72 is “detection”.

The regions I to IV are specified based on the detection results of the remaining amount detection sensors 71 and 72, and switching between the replenishing operation and the supplying operation can be performed. The remaining amount can be estimated using the discharge amount of the liquid L discharged from the discharge head 11 together. In this case, the number of dots of the liquid L discharged from the discharge head 11 is counted and accumulated, and the average discharge amount per dot is multiplied, thereby calculating the approximate value of the consumed liquid amount (so-called dot count). When the dot count is used together, the remaining amount can be estimated more finely than in the discrimination of the four regions I to IV.

### Check Valves

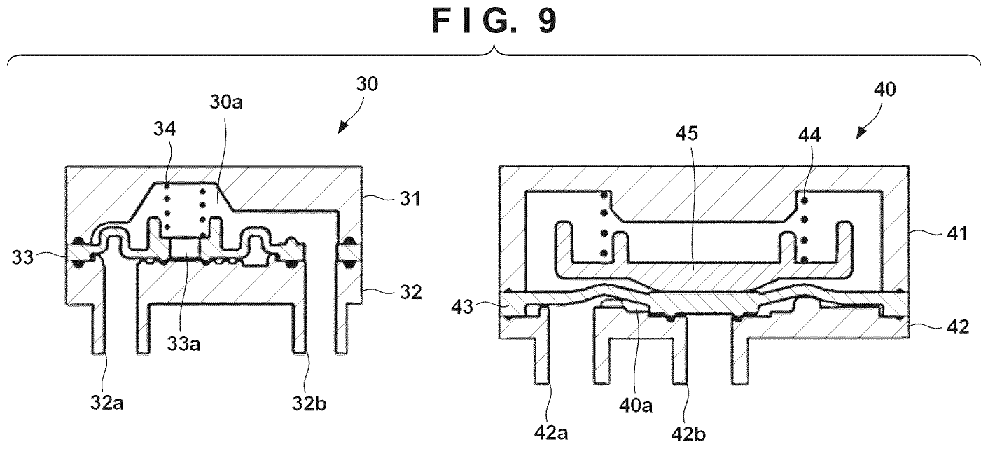

The structures of the check valves 30 and 40 will be described with reference to FIG. 9. FIG. 9 is an explanatory view of the structures of the check valves 30 and 40.

The check valve 30 includes a housing member 31 on the upper side, a housing member 32 on the lower side, and a diaphragm 33 sandwiched between these. The diaphragm 33 is a flexible film made of rubber or elastomer resin. The housing member 32 includes an inflow pipe 32a that forms an inlet of the liquid L, and an outflow pipe 32b that forms an outlet. The pipe 19a is connected to the inflow pipe 32a, and the pipe 19b is connected to the outflow pipe 32b. A communicating path 30a of the liquid L, which communicates with the outlet, is formed between the housing member 31 and the housing member 32. A through hole 33a through which the liquid L passes is formed in the diaphragm 33. The diaphragm 33 is arranged between the communicating path 30a and the inflow pipe 32a and pressed against the housing member 32 by a coil spring 34, thereby cutting off communication between the communicating path 30a and the inflow pipe 32a.

The check valve 30 operates as a so-called differential pressure valve. If the pressure in the inflow pipe 32a equals the pressure in the outflow pipe 32b, as shown in FIG. 9, the diaphragm 33 is pressed against the housing member 32 by the coil spring 34, and communication between the communicating path 30a and the inflow pipe 32a is cut off. That is, the channel of the liquid L is closed. Even in a case where the pressure in the inflow pipe 32a is lower than the pressure in the outflow pipe 32b, similarly, the channel of the liquid L is closed.

On the other hand, if the pressure in the inflow pipe 32a is higher than the pressure in the outflow pipe 32b, the diaphragm 33 is raised from the housing member 32 near the through hole 33a, and the inflow pipe 32a and the outflow pipe 32b communicate with each other via the through hole 33a and the communicating path 30a. That is, the channel of the liquid Lis released.

With the above-described action, if the liquid chamber 20a of the intermediate tank 20 is set to a negative pressure, the check valve 30 is opened, and the liquid L is sucked from the container 17 to the liquid chamber 20a. To the contrary, if the liquid chamber 20a of the intermediate tank 20 is set to a positive pressure, the check valve 30 is closed to prevent the liquid L from flowing backward from the liquid chamber 20a to the container 17.

The check valve 40 includes a housing member 41 on the upper side, a housing member 42 on the lower side, and a diaphragm 43 sandwiched between these. The diaphragm 43 is a flexible film made of rubber or elastomer resin. The housing member 42 includes an inflow pipe 42a that forms an inlet of the liquid L, and an outflow pipe 42b that forms an outlet. The pipe 19c is connected to the inflow pipe 42a, and the pipe 19d is connected to the outflow pipe 42b. A communicating path 40a of the liquid L, which communicates with the outlet, is formed between the housing member 41 and the housing member 42. The diaphragm 43 includes a portion that closes the outflow pipe 42b. This portion is pressed to the side of the housing member 42 by a coil spring 44 via a pressurizing plate 45, thereby cutting off communication between the communicating path 40a and the outflow pipe 42b.

The check valve 40 also operates as a so-called differential pressure valve. If the pressure in the inflow pipe 42a equals the pressure in the outflow pipe 42b, as shown in FIG. 9, the diaphragm 43 is pressed to the side of the housing member 42 by the coil spring 44, and communication between the communicating path 40a and the outflow pipe 42b is cut off. That is, the channel of the liquid Lis closed. Even in a case where the pressure in the inflow pipe 42a is lower than the pressure in the outflow pipe 42b, similarly, the channel of the liquid L is closed.

On the other hand, if the pressure in the inflow pipe 42a is higher than the pressure in the outflow pipe 42b, the diaphragm 43 is raised, and the inflow pipe 42a and the outflow pipe 42b communicate with each other via the communicating path 40a. That is, the channel of the liquid L is released.

With the above-described action, if the liquid chamber 20a of the intermediate tank 20 is set to a positive pressure, the check valve 40 is opened, and the liquid L is supplied from the liquid chamber 20a to the side of the discharge head 11. To the contrary, if the liquid chamber 20a of the intermediate tank 20 is set to a negative pressure, the check valve 40 is closed to prevent the liquid L from flowing backward from the side of the discharge head 11 to the liquid chamber 20a.

Note that it is possible to execute a step called a suction operation of applying a negative pressure to the nozzle portion of the discharge head 11 using a negative pressure pump (not shown). In this case, the pressure chamber 20b is set to the atmospheric pressure, and the liquid chamber 20a is set to the atmospheric pressure. That is, this step is executed by setting the inside of the inflow pipe 42a to substantially the atmospheric pressure. When the pressure chamber 20b is directly set to a positive pressure, the check valve 40 can be opened, and the liquid L can be supplied at once from the liquid chamber 20a to the discharge head 11 at a high flow velocity.

### Negative Pressure Maintaining Unit

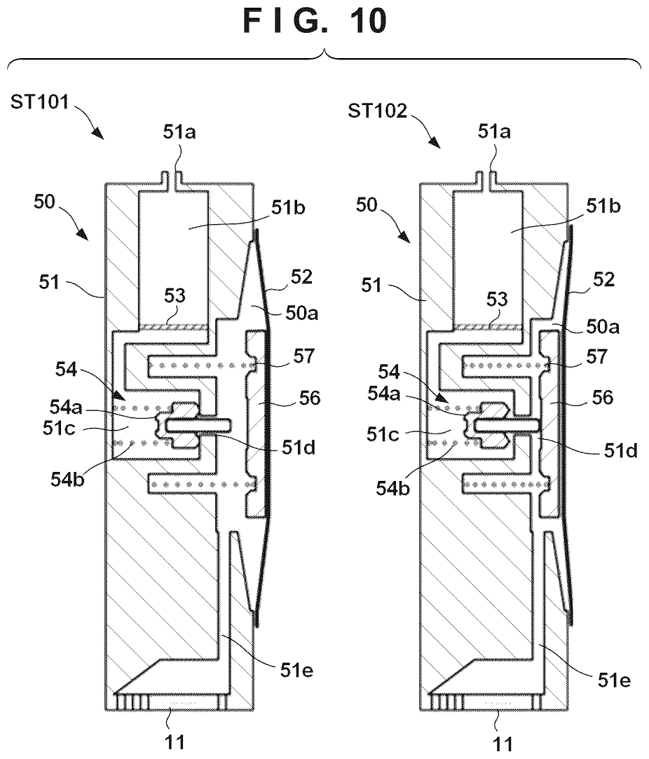

The structure and operation of the negative pressure maintaining unit 50 will be described with reference to FIG. 10. FIG. 10 is an explanatory view of the structure and operation of the negative pressure maintaining unit 50. A state ST101 indicates a state in which the storage amount of the liquid Lis large, and a state ST102 indicates a state in which the storage amount of the liquid Lis small.

The negative pressure maintaining unit 50 includes a housing 51 provided with the discharge head 11 and forms a discharge head module. The housing 51 includes an inflow pipe 51a that forms an inlet in which the liquid L supplied from the intermediate tank 20 flows, and a channel 51b communicating with the inflow pipe 51a. The pipe 19d is connected to the inflow pipe 51a. A filter 53 is provided in the channel 51b, and various mixed substances are removed when the liquid L flows into the channel 51b and passes through the filter 53.

The housing 51 also includes channels 51c and 51e and a storage portion 50a. A part of the peripheral wall of the storage portion 50a is formed by a diaphragm 52. The storage portion 50a is provided between the discharge head and the liquid chamber 20a of the intermediate tank 20 and communicates with the discharge head 11 via the channel 51e. The storage portion 50a is a liquid chamber that temporarily stores, before the discharge head 11, the liquid L supplied from the liquid chamber 20a at a predetermined negative pressure force, and prevents the liquid L from leaking from the discharge head 11.

The diaphragm 52 is a deformation sheet member that is made of a flexible material and partitions the storage portion 50a. A moving plate 56 is adhered to the diaphragm 52. The diaphragm 52 and the moving plate 56 are always biased by an elastic member 57 in a direction of increasing the capacity of the storage portion 50a. The elastic member 57 is a coil spring put between the housing 51 and the moving plate 56 and maintains the storage portion 50a in a negative pressure state by the biasing force of the elastic member 57.

The channel 51c is provided with a limiting valve 54 that limits supply of the liquid L from the channel 51c to the storage portion 50a. The limiting valve 54 is a valve that opens/closes a communicating path 51d between the channel 51c and the storage portion 50a. The limiting valve 54 includes a valve element 54a and an elastic member 54b, and the valve element 54a is always biased in a closing direction by the elastic member 54b. The valve element 54a includes a shaft portion that passes through the communicating path 51d and enters the storage portion 50a.

The operation of the negative pressure maintaining unit 50 will be described. In the state ST101, the limiting valve 54 is closed. In other words, the storage portion 50a is filled with a sufficient amount of liquid L. When the valve element 54a is adhered to the wall portion around the communicating path 51d, flow of the liquid L from the channel 51c to the storage portion 50a is limited. In this state, a force in a direction of expanding the storage portion 50a is applied from the elastic member 57 to the diaphragm 52 via the moving plate 56. In addition, since the limiting valve 54 is closed, the liquid in the storage portion 50a is in a negative pressure state. Thus, when discharging the liquid L from the nozzles of the discharge head, a meniscus formed in each nozzle can be set to a desirable state (appropriately recessed state). Note that in the state ST101 shown in FIG. 10, the expansion of the diaphragm 52 is expressed in a slightly exaggerated state.

The state ST102 indicates a state in which the limiting valve 54 is opened. In other words, the state in which the limiting valve 54 is opened is a state in which the remaining amount in the storage portion 50a is short and liquid supply from the intermediate tank 20 is awaited. If the capacity in the storage portion 50a decreases along with the discharge of the liquid L from the discharge head, the diaphragm 52 is displaced, against the elastic member 57, to the side of the limiting valve 54. When the moving plate 56 presses the valve element 54a of the limiting valve 54 and the valve element 54a is separated from the wall portion around the communicating path 51d, the liquid L can flow from the channel 51c to the storage portion 50a via the communicating path 51d. Since the liquid L entered from the inflow pipe 51a is pressurized, it passes through the filter 53 and flows into the storage portion 50a via the communicating path 51d.

When the liquid amount in the storage portion 50a increases, the diaphragm 52 gradually expands, and parallelly, the moving plate 56 moves in a direction of separating from the valve element 54a. As a result, the limiting valve 54 is closed, like the state ST101.

In this way, while maintaining the storage portion 50a at the negative pressure, the liquid L is pressurized and supplied from the intermediate tank 20 to the storage portion 50a. FIG. 10 shows the displacement of the diaphragm 52 in an exaggerated state. In fact, the closed state and the open state are repeated with a small movement amount, and the inside of the storage portion 50a can be kept at an almost constant negative pressure.

### Pressure Adjusting Unit

The configuration of the pressure adjusting unit 60 will be described. FIG. 11 is an explanatory view of the pressure adjusting unit 60. The pressure adjusting unit 60 includes an air pump 61, and a plurality of control valves 62A to 62D. The air pump 61 is an electric pump that incorporates a diaphragm, a check valve, and the like and uses a motor as a driving source. Each of the plurality of control valves 62A to 62D is an electric valve that switches the communicating state of the pressure chamber 20b to the air pump 61 or the pipe 19f forming an air communicating path.

In this embodiment, a pressure sensor 73 and a constant pressure valve 63 are provided on the pipe 19e. The pressure sensor 73 detects the pressure of a gas in the pipe 19e, that is, the pressure in the pressure chamber 20b. The constant pressure valve 63 is a valve that maintains the pressure chamber 20b at not more than an upper limit pressure when pressurizing the pressure chamber 20b. When the pressure in the pipe 19e reaches the upper limit pressure, the constant pressure valve 63 is opened to make the pipe 19e communicate with the air. This maintains the pressure chamber 20b at not more than the upper limit pressure.

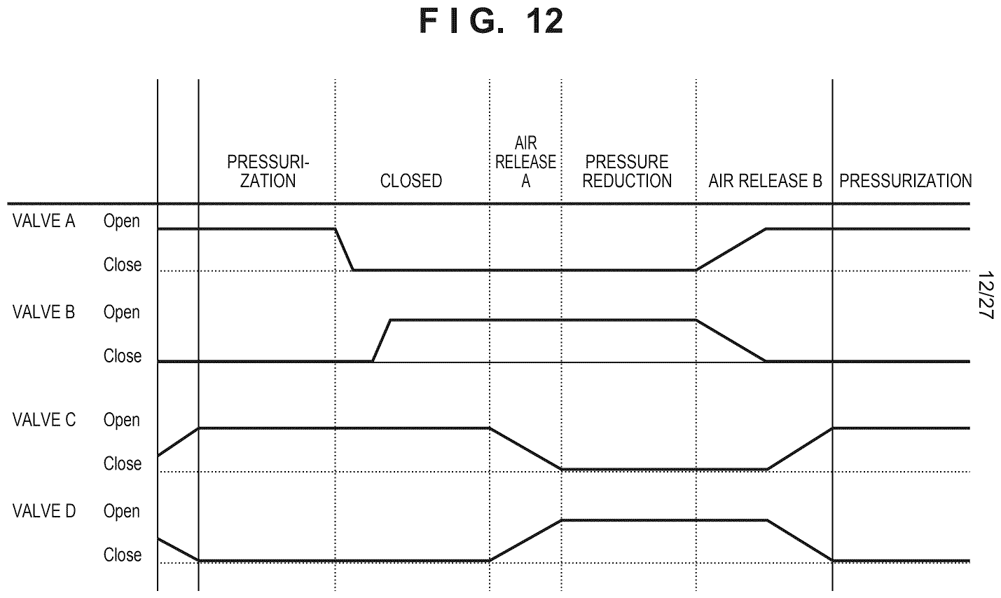

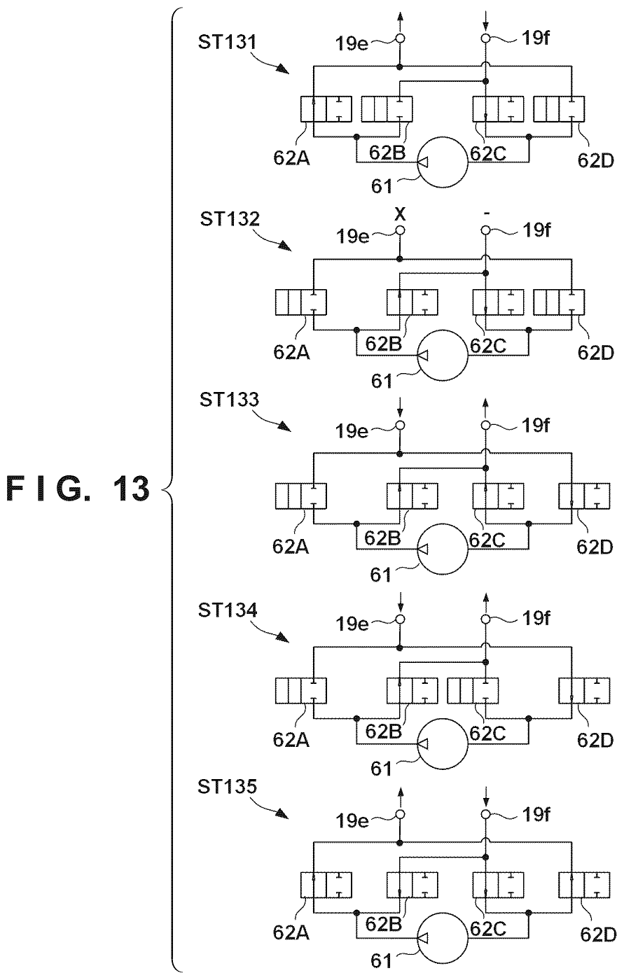

FIG. 12 is a view (timing chart) showing the open/close patterns of the control valves 62A to 62D. In FIG. 12, valves A to D mean the control valves 62A to 62D. Pressurization, closing, air release A, pressure reduction, air release B, and pressurization along the abscissa indicate the operation of the pressure adjusting unit 60 to the pressure chamber 20b. FIG. 13 is an explanatory view of an operation in a case where the control valves 62A to 62D are opened/closed in the order of pressurization, closing, air release A, pressure reduction, and air release B shown along the abscissa of FIG. 12.

A state ST131 shown in FIG. 13 indicates valve states in a pressurization operation for setting the pressure chamber 20b in a positive pressure state. The control valve 62A is open, the control valve 62B is closed, the control valve 62C is open, and the control valve 62D is closed. When the air pump 61 is driven in the valve states, air is sucked from the side of the pipe 19f, and pressurized air is sent to the pipe 19e. When pressure adjustment is performed by the pressurization operation, the pressure chamber 20b gradually changes from the atmospheric pressure state to a positive pressure. If the pressure in the pipe 19f exceeds the upper limit pressure after a predetermined time, the constant pressure valve 63 operates to make the pressure in the pressure chamber 20b constant.

A state ST132 indicates valve states in a closing operation for maintaining the pressure in the pressure chamber 20b pressurized by the pressurization operation. The control valve 62A is closed, the control valve 62B is open, the control valve 62C is open, and the control valve 62D is closed. In the valve states, the side of the pipe 19e (pressure chamber 20b) is disconnected from the air pump 61 and closed. When the air pump 61 is being driven, air circulates between the control valve 62B, the control valve 62C, and the air pump 61. Hence, air does not flow to the side of the pipe 19f in both the state in which the air pump 61 is operating and the state in which it is stopped.

A state ST133 indicates an air release A operation that is performed halfway through the transition to the next pressure reducing operation. This operation is an operation for making the pressure chamber 20b communicate with the air and returning it from the positive pressure state to substantially the atmospheric pressure in order to quickly change the pressure chamber 20b from the positive pressure state to a negative pressure state. In the air release A operation, the control valve 62A is closed, the control valve 62B is open, the control valve 62C is open, and the control valve 62D is open. In this case, air enters from the side of the pipe 19e, passes through the control valve 62D and the control valve 62C in this order, and exits to the pipe 19f without passing through the air pump 61.

A state ST134 indicates valve states in a pressure reducing operation for setting the pressure chamber 20b in a negative pressure state. The control valve 62A is closed, the control valve 62B is open, the control valve 62C is closed, and the control valve 62D is open. When the air pump 61 is driven in the valve states, air is sucked from the side of the pipe 19e and discharged to the side of the pipe 19f. When pressure adjustment is performed by the pressure reducing operation in the atmospheric pressure state of the pressure chamber 20b, the pressure chamber 20b gradually changes to a negative pressure. After a predetermined time, the pressure in the pressure chamber 20b becomes constant at a predetermined negative pressure according to the capability of the air pump 61. Note that in this embodiment, no constant pressure valve is provided on the negative pressure side. To limit the pressure to a predetermined negative pressure, a negative pressure side constant pressure valve may be provided in parallel to the constant pressure valve 63.

A state ST135 indicates an air release B operation that is performed halfway through the transition to the next pressurization operation (state ST131). This operation is an operation for making the pressure chamber 20b communicate with the air and returning it from the negative pressure to substantially the atmospheric pressure in order to quickly change the inside of the pressure chamber 20b from the negative pressure state to a positive pressure state. In the air release B operation, the control valve 62A is open, the control valve 62B is open, the control valve 62C is open, and the control valve 62D is open. In this case, air enters from the side of the pipe 19f, passes through the control valve 62B and the control valve 62A in this order, and enters the pipe 19e without passing through the air pump 61.

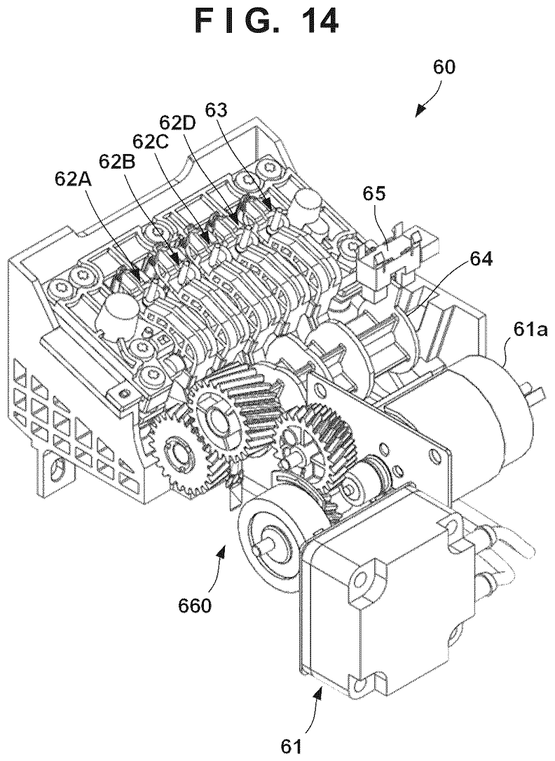

FIG. 14 is a view showing a detailed example of the structure of the pressure adjusting unit 60. In this structure example, not only the air pump 61, the control valves 62A to 62D, and the constant pressure valve 63 but also a motor serving as a driving source, a position detection sensor, and the like are unitized.

A motor 61a drives the air pump 61 and the control valves 62A to 62D. A cam sensor 65 detects the initial position of a cam member 64. A driving gear train 660 selectively transmits the driving force of the motor 61a to the air pump 61 and the cam member 64. Also, the driving gear train 660 includes a clutch mechanism. Normally, when the motor 61a is rotated in the forward direction, the cam member 64 does not move, and only the air pump 61 operates. It is also possible to, by the action of the clutch mechanism, rotate the motor 61a in the forward direction and rotate the cam member 64 in the reverse direction. The cam member 64 includes a plurality of plate cams that give the timing and force for switching the control valves 62A to 62D, and a cam shaft.

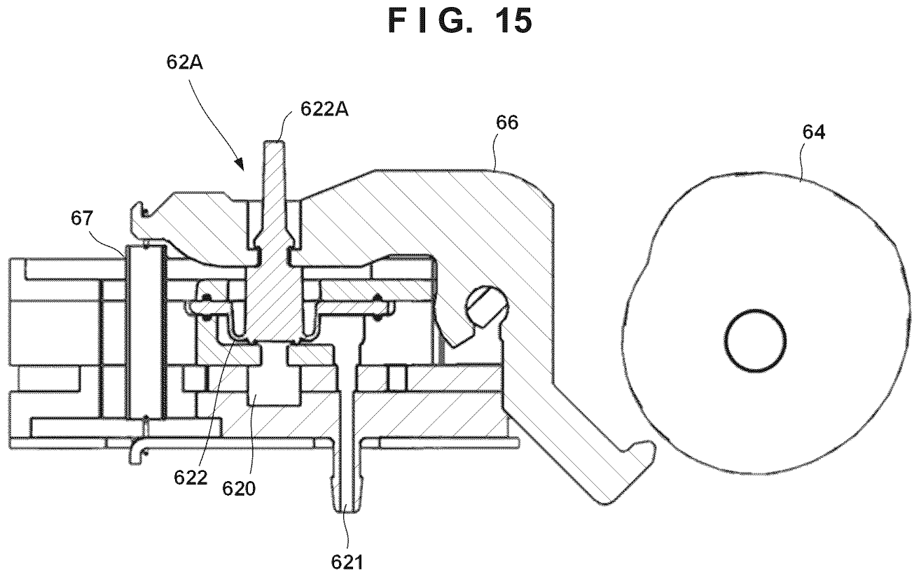

FIG. 15 is a schematic sectional view showing the configuration of the control valve 62A as a representative. A cam lever 66 has a cam follower function for the cam member 64 and a function of displacing a valve rubber 622. A cam lever spring 67 biases the cam lever 66 in a direction of closing the valve. The valve rubber 622 forms a closed space and also presses a part thereof against a counter portion to control the valve function itself. A seal portion 622A is a valve element that is a part of the valve rubber 622 and is deformed when pressed against the counter portion to form a seal. A channel 620 is channel on the upstream side of the control valve 62A, and a channel 621 is a channel on the downstream side of the control valve 62A. Along with the rotation of the cam member 64, the cam lever 66 rotates and displaces the seal portion 622A. Thus, communication and cutoff between the channel 620 and the channel 621 can be switched.

The positions of the cam member 64 corresponding to the pressurization operation, the closing operation, the air release A operation, the pressure reducing operation, and the air release B operation exemplified in FIGS. 12 and 13 are sometimes called a pressurization position, a closing position, an air release A position, a pressure reducing position, and an air release B position, respectively.

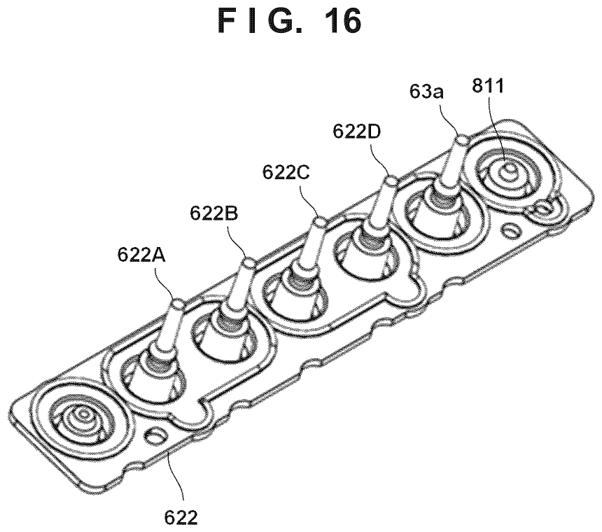

In this embodiment, the valve rubber 622 is integrally formed as a component by the control valves 62A to 62D, the constant pressure valve 63, and a differential pressure valve 81 to be described later. FIG. 16 is a perspective view of the valve rubber 622. The valve rubber 622 includes not only the above-described seal portion 622A but also seal portions 622B to 622D that form the control valves 62B to 62D, a seal portion 63a that forms the constant pressure valve 63, and a seal portion 811 that forms the differential pressure valve 81 to be described later. The seal portions 622A to 622D, 63a, and 811 include diaphragms of the control valves 62A to 62D, the constant pressure valve 63, and the differential pressure valve 81, respectively, and can independently operate. However, as components, the seal portions 622A to 622D, 63a, and 811 are integrally formed as the valve rubber 622.

By the pressure adjusting unit 60 having the above-described configuration, the pressure state of the pressure chamber 20b can be adjusted. The operation of the pressure adjusting unit 60 is roughly divided into the operation of the air pump 61 and the switching operation of the control valves 62A to 62D.

The driving gear train 660 is configured to, when the air pump 61 operates, transmit the driving force from the motor 61a only to the side of the air pump 61. More specifically, when the motor 61a is being rotated in the forward direction, the air pump 61 is continuously driven. At the time of the switching operation of the control valves 62A to 62D, the motor 61a is rotated in the reverse direction. The driving gear train 660 is configured to, in this case, transmit the driving force of the motor 61a to both the side of the air pump 61 and the side of the cam member 64. When the motor 61a is rotated in the reverse direction, the air pump 61 is driven by rotation in a direction opposite to that in rotation of the motor 61a in the forward direction. However, the air pump 61 is configured to similarly act as a pump regardless of the direction of driving.

The cam member 64 is rotated by the driving force transmitted to the cam member 64, and the control valves 62A to 62D are opened/closed by the same mechanism and operation as the control valve 62A shown as a representative example in FIG. 15. That is, in the valve closed state shown in FIG. 15, the valve rubber 622 is pressed in the downward direction in FIG. 15 via the cam lever 66 by the action of the cam lever spring 67. The seal portion 622A is pressed against the counter portion and thus deformed and adhered, thereby cutting off communication between the channel 620 and the channel 621.

When the cam member 64 rotates, and the convex portion of the cam face abuts against the cam lever 66, the cam lever 66 rotates clockwise in FIG. 15 against the cam lever spring 67. The valve rubber 622 is raised in the upward direction in FIG. 15, the seal portion 622A is separated from the counter portion, and the channel 620 and the channel 621 communicate with each other. The cam face of the cam member 64 is configured to open/close the control valves 62A to 62D at appropriately timings along the timing chart shown in FIG. 12. It is possible to implement transition to a desired operation state only by rotating the cam member 64 as desired.

Note that in this embodiment, air is used as a pressure adjusting fluid for the pressure chamber 20b. However, a liquid working fluid such as hydraulic pressure may be used. In this case, in place of air release, a buffer tank for the liquid working fluid is provided, the liquid working fluid is made to escape into it, and the buffer tank is set to the atmospheric pressure.

### Air Release Unit

The air release unit 80 is a mechanism that releases the pressure chamber 20b to the air in accordance with an operation (to be referred to as an exchange-associated operation hereinafter) associated with exchange of the container 17. In this embodiment, the exchange-associated operation is the operation of opening the access covers 16A and 16B. If the access cover 16A or 16B is opened, a corresponding container 17 may be exchanged by the user. For example, if the access cover 16A is opened, at least one of the containers 17 stored in the storage unit 15A may be exchanged. Also, if the access cover 16B is opened, the container 17 stored in the storage unit 15B may be exchanged.

Exchange of the container 17 can be performed by the user at an arbitrary timing. If the container 17 corresponding to the intermediate tank 20 of the pressure chamber 20b is exchanged in a case where the pressure chamber 20b is in the negative pressure state, as in the replenishing operation, bubbles may be sucked from the pipe 19a into the channel of the liquid L. If bubbles are sucked into the channel, a liquid discharge failure of the discharge head 11 may occur. The air release unit 80 cancels the negative pressure state by releasing the pressure chamber 20b to the air in such a case and prevent bubbles from being sucked from the pipe 19a into the channel of the liquid L.

On the other hand, even if the container 17 corresponding to the intermediate tank 20 of the pressure chamber 20b is exchanged in a case where the pressure chamber 20b is in the positive pressure state, as in the supplying operation, the possibility that bubbles are sucked from the pipe 19a into the channel of the liquid Lis low. To release the pressure chamber 20b to the air, it may be necessary to interrupt the printing operation, and productivity lowers. The air release unit 80 according to this embodiment releases the pressure chamber 20b to the air in accordance with the exchange-associated operation and the operation state of the pressure adjusting unit 60.

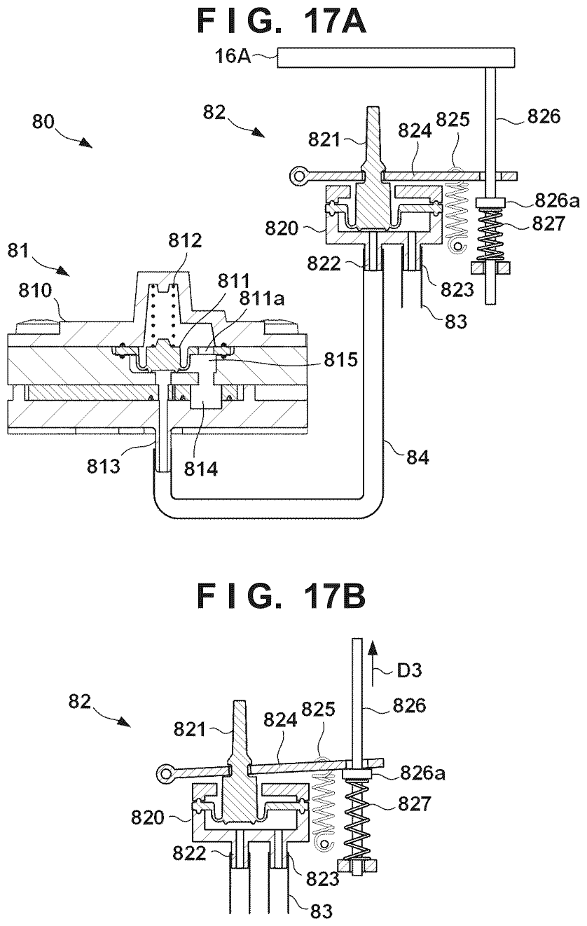

FIG. 17A is an explanatory view showing the structure of the air release unit 80. The air release unit 80 includes the differential pressure valve 81 and an interlocking valve 82. The differential pressure valve 81 includes a housing 810, the seal portion (valve element) 811, and an elastic member 812. A passage 814 that communicates with the pressure chamber 20b via the pipe 19e and a communicating path 815 that communicates with the passage 814 are formed inside the housing 810. Also, the housing 810 includes a communicating pipe 813 that forms a communicating path to the interlocking valve 82. A pipe 84 is connected to the communicating pipe 813. The seal portion 811 that opens/closes the communicating pipe 813 is provided inside the housing 810. A through hole 811a is formed in the seal portion 811, and the passage 814 always communicates with a space where the elastic member 812 is arranged. The seal portion 811 is always biased, by the elastic member 812, in a direction of closing the communicating pipe 813. The elastic member 812 is, for example, a coil spring.

In the differential pressure valve 81, if the pressure in the communicating pipe 813 is equal to or lower than the pressure in the passage 814, the seal portion 811 closes the communicating pipe 813. On the other hand, if the pressure in the communicating pipe 813 is higher than the pressure in the passage 814, the seal portion 811 is displaced in a direction of separating from the communicating pipe 813 against the bias of the elastic member 812, thereby releasing the communicating pipe 813. The communicating pipe 813 and the passage 814 thus communicate with each other. In this embodiment, the differential pressure valve 81 is a valve that releases the communicating pipe 813 when the pressure in the pressure chamber 20b is lower than the atmospheric pressure, and acts to close the communicating pipe 813 otherwise.

Note that the seal portion 811 is formed as a part of the valve rubber 622, as shown in FIG. 16, and other members forming the valve are also shared, thereby reducing the size and cost of the apparatus.

The interlocking valve 82 includes a housing 820, a seal portion (valve element) 821, a lever 824, an elastic member 825, a rod 826, and an elastic member 827. In the example shown in FIG. 17A, the interlocking valve 82 that interlocks with opening/closing of the access cover 16A is exemplified. The interlocking valve 82 that interlocks with opening/closing of the access cover 16B has the same configuration. Note that in FIG. 17A, the access cover 16A is expressed in a simplified form.

The housing 820 includes a communicating pipe 822 that forms a communicating path to the differential pressure valve 81, and a communicating pipe 823 that forms a communicating path to the air. The pipe 84 is connected to the communicating pipe 822, and a pipe 83 released to the air is connected to the communicating pipe 823. The seal portion 821 that opens/closes the communicating pipe 822 is provided inside the housing 820.

The rod 826 is a member that engages with the access cover 16A. In this embodiment, the distal end of the rod 826 abuts against the access cover 16A in a case where the access cover 16A is in a closed state. The elastic member 827 always biases the rod 826 in a direction of making the distal end abut against the access cover 16A. The elastic member 827 is, for example, a coil spring. If the access cover 16A is in the closed state as shown in FIG. 17A, the elastic member 827 is in a contracted state and accumulates the elastic force.

The lever 824 has its one end portion axially supported and can freely rotate about the axis. If the rod 826 is displaced upward in FIG. 17A, the lever 824 engages with an engaging portion 826a of the rod 826 and rotates. The seal portion 821 is thus displaced in a direction of releasing the communicating pipe 822. When the seal portion 821 releases the communicating pipe 822, the communicating pipe 822 and the communicating pipe 823 communicate with each other. That is, the communicating pipe 813 of the differential pressure valve 81 is released to the air.

The elastic member 825 biases the lever 824 downward in FIG. 17A. The elastic member 825 is, for example, a coil spring. By the elastic member 825, the lever 824 always biases the seal portion 821 in a direction of closing the communicating pipe 822. When the seal portion 821 closes the communicating pipe 822, communication between the communicating pipe 822 and the communicating pipe 823 is cut off. That is, the communicating pipe 813 of the differential pressure valve 81 is cut off from the air.

With the above-described configuration, the interlocking valve 82 opens/closes while mechanically interlocking with opening/closing of the access cover 16A. That is, as shown in FIG. 17A, if the access cover 16A is in the closed state, the seal portion 821 closes the communicating pipe 813, and the interlocking valve 82 is in the closed state. On the other hand, if the access cover 16A is opened, as shown in FIG. 17B, the rod 826 is displaced in a direction D3 by the bias of the elastic member 827, the lever 824 rotates, and the seal portion 821 releases the communicating pipe 823. The interlocking valve 82 is thus set in the open state, and the communicating pipe 822 and the communicating pipe 823 communicate with each other. If the access cover 16A is set in the closed state again, the state returns to the state shown in FIG. 17A.

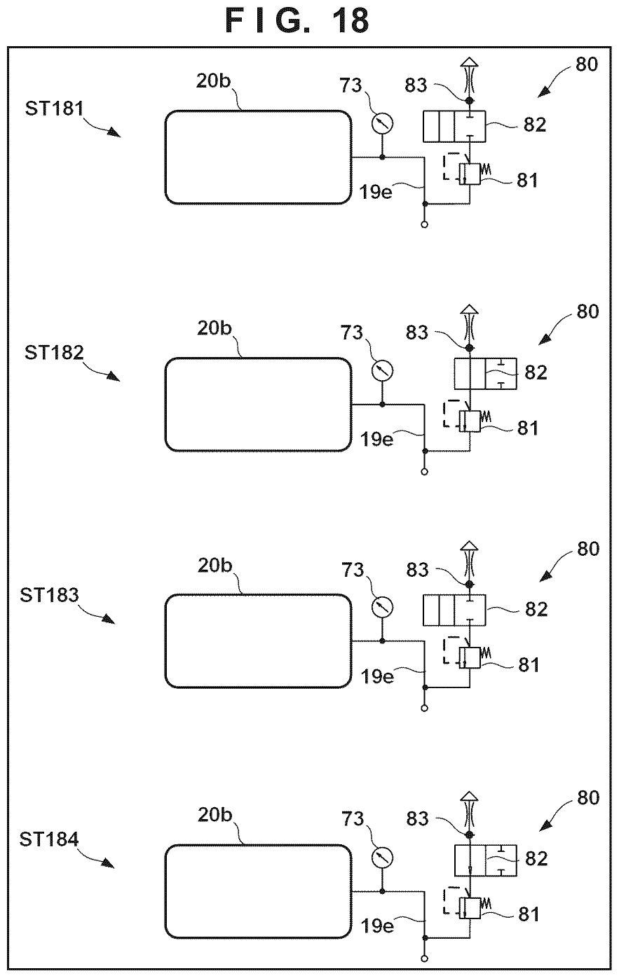

FIG. 18 is an explanatory view of the operation of the air release unit 80 in association with the exchange operation of the container 17. A state ST181 indicates a state in which the pressure chamber 20b is in the positive pressure state and the access cover 16A is closed. This state is a state when the supplying operation is executed by the pressure adjusting unit 60. At this time, since the interlocking valve 82 is closed, the pressure in the communicating pipe 813 does not vary, and the same positive pressure as in the pressure chamber 20b is applied to the passage 814. Hence, the differential pressure valve 81 is also closed. That is, in this state, the pressure in the pressure chamber 20b is not influenced by the differential pressure valve 81 and the interlocking valve 82.

A state ST182 indicates a state in which the pressure chamber 20b is in the positive pressure state and the access cover 16A is opened. Here, in the printing apparatus 1 according to this embodiment, even in a wait state in which the printing operation is not performed or in a power-off state in which the printing apparatus 1 is powered off, the pressure chamber 20b is kept in the positive pressure state. This aims at waiting such that the supplying operation can be performed immediately upon receiving an instruction to the next printing operation. In addition, since the channel from the intermediate tank 20 to the limiting valve 54 on the downstream side is kept pressurized, the phenomenon that air enters into the channel can be suppressed. Hence, the state ST182 corresponds to a state in a case where the access cover 16A is opened during execution of the supplying operation in the printing operation of the printing apparatus 1, in the wait state before the next printing operation, or in the power-off state. At this time, the interlocking valve 82 is opened. Since the communicating pipe 813 is released to the air, and the same positive pressure as in the pressure chamber 20b is applied to the passage 814, the differential pressure valve 81 is kept closed. That is, in this state, the pressure in the pressure chamber 20b is not changed by opening the access cover 16A because of the action of the differential pressure valve 81 and the interlocking valve 82.

A state ST183 indicates a state in which the pressure chamber 20b is in the negative pressure state and the access cover 16A is closed. This state is a state when the replenishing operation is executed. At this time, since the interlocking valve 82 is closed, the pressure in the communicating pipe 813 does not vary, and the same negative pressure as in the pressure chamber 20b is applied to the passage 814. At this time, a force for opening the seal portion 811 acts on the valve rubber 622 of the differential pressure valve 81. However, since the interlocking valve 82 is closed and the air does not flow, the differential pressure valve 81 is not opened and is kept closed. That is, in this state, the pressure in the pressure chamber 20b is not influenced by the differential pressure valve 81 and the interlocking valve 82.

A state ST184 indicates a state in which the pressure chamber 20b is in the negative pressure state and the access cover 16A is opened. This state corresponds to a state in which the access cover 16A is opened due to some reason.

The replenishing operation is executed at an arbitrary timing during the period in which the printing operation is not being executed. In such specifications that the operation is performed without making the user be aware of the execution timing, the user may happen to open the access cover 16A to exchange the container 17 during the replenishing operation.

If the user just opens the access cover 16A, any particular problems do not occur. However, a problem occurs if the container 17 is removed from the storage unit 15A during the replenishing operation. The problem is that air enters from a joint portion connecting the container 17 and the pipe 19a. If air enters the channel and reaches the discharge head 11, a failure may occur in the discharging operation.

The air enters from the joint portion because the channel from the container 17 to the intermediate tank 20 is set in the negative pressure state. This is because the pressure in the pressure chamber 20b is reduced to set the negative pressure state for the replenishing operation. Hence, if the user opens the access cover 16A during the replenishing operation, the pressure chamber 20b is quickly returned from the negative pressure state to the atmospheric pressure state to suppress entering of air into the channel.

In the state ST184, the interlocking valve 82 is opened, and the communicating pipe 813 is released to air. Since the same negative pressure as in the pressure chamber 20b is applied to the passage 814, the differential pressure valve 81 is opened. When the differential pressure valve 81 is opened, the air flows into the pressure chamber 20b at once, and the pressure chamber 20b changes to the atmospheric pressure state in a short time. That is, in this state, by the action of the differential pressure valve 81 and the interlocking valve 82, the state in the pressure chamber 20b quickly changes from the negative pressure state to the atmospheric pressure state by opening the access cover 16A. Hence, even if the user removes the container 17 from the storage unit 15A, entering of air into the channel is suppressed.

As described above, according to this embodiment, when the pressure chamber 20b is in the positive pressure state, the positive pressure state in the pressure chamber 20b is maintained even if the access cover 16A is opened. Hence, even if the user opens the access cover 16A at an arbitrary timing, it is possible to avoid a situation in which downtime for re-pressurization is needed before the next printing operation. Also, even in the wait state after that, pressurization in the channel from the intermediate tank 20 to the limiting valve 54 can be maintained and, therefore, the phenomenon that air enters into the channel can be suppressed.

On the other hand, in a case where the pressure chamber 20b is in the negative pressure state, when the access cover 16A is opened, the pressure in the pressure chamber 20b quickly returns from the negative pressure state to the atmospheric pressure. Hence, even if the user opens the access cover 16A during the replenishing operation, it is possible to suppress unintended entering of air into the liquid channel.

Note that in this embodiment, the differential pressure valve 81 is arranged closer to the pressure chamber 20b than the interlocking valve 82. However, if these are connected in series, the positions may be replaced.

### Control Circuit

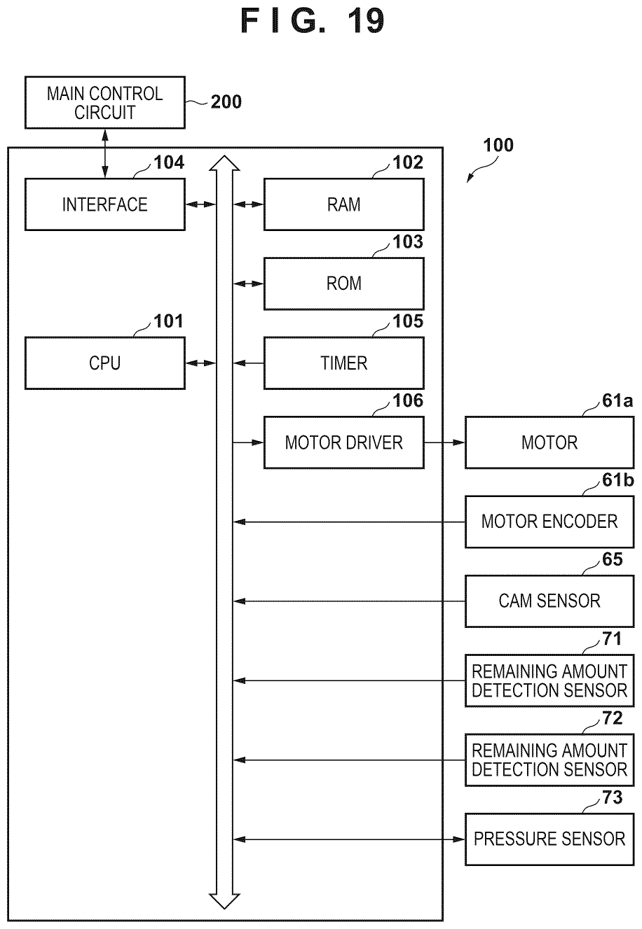

The control circuit of the supplying unit 18 will be described. FIG. 19 is a block diagram showing a control circuit 100 of the supplying unit 18. The control circuit 100 includes at least one processor and at least one storage device, and the processor executes a program stored in the storage device. More specifically, the control circuit 100 includes a CPU 101, a RAM 102, and a ROM 103. The ROM 103 stores programs and various kinds of settings. The RAM 102 temporarily stores programs and control information. The CPU 101 executes the programs stored in the ROM 103.

The CPU 101 can communicate with a main control circuit 200 of the printing apparatus 1 via an interface 104. The main control circuit 200 performs control of the printing operation, and the like. Control to be executed by the control circuit 100 may be executed by the main control circuit 200.

A timer 105 counts time. A motor driver 106 drives the motor 61a in accordance with an instruction from the CPU 101. A motor encoder 61b detects the rotation direction and angle of the motor 61a. The CPU 101 can control the motor 61a based on the detection results of the motor encoder 61b, the cam sensor 65, the remaining amount detection sensors 71 and 72, and the pressure sensor 73.

### Example of Control

An example of control of the supplying unit 18 executed by the CPU 101 of the control circuit 100 will be described.

### Replenishing Operation

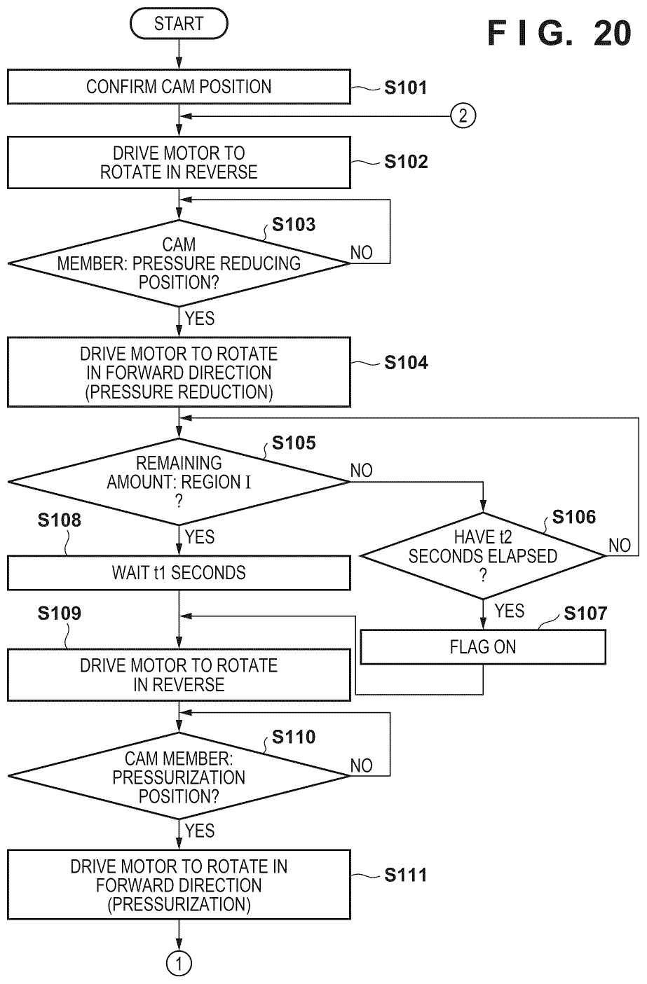

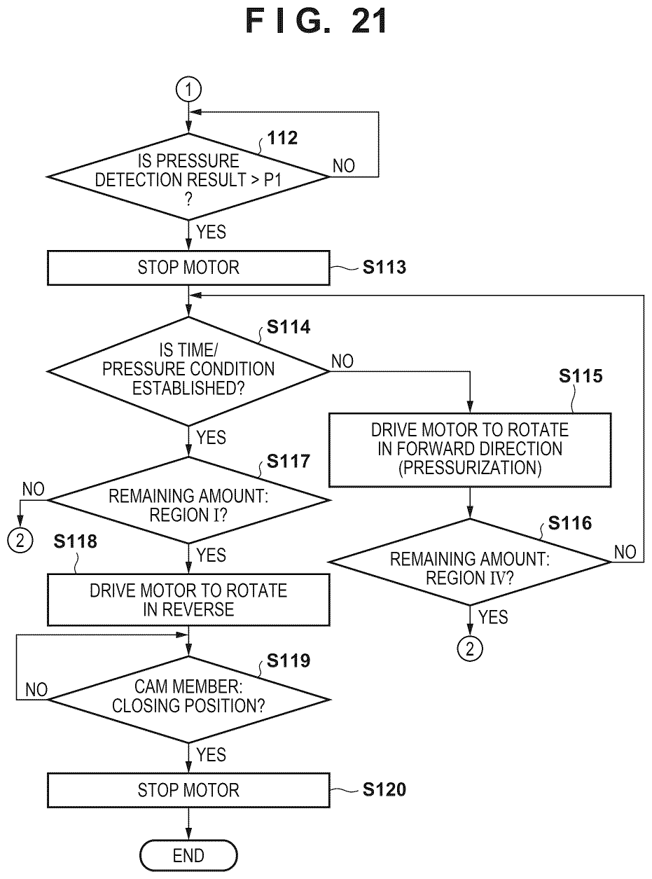

FIGS. 20 and 21 are flowcharts showing an example of processing of the replenishing operation. This processing is an operation for obtaining the state of a total capacity of 100% indicated by the state ST62 shown in FIG. 6 when the remaining amount of the liquid L in the liquid chamber 20a decreases. This operation is executed basically in a case where the remaining amount of the liquid L in the liquid chamber 20a decreases to the region II or less.

In step S101, it is confirmed that the cam member 64 is located at the closing position. This embodiment assumes that in the wait state of the printing apparatus 1, the cam member 64 is located at the closing position and the pressure chamber 20b is maintained in the positive pressure state. If the printing apparatus waits in the positive pressure state, the pressure chamber 20b may not be re-pressurized when transiting from the wait state to the next printing operation, and the printing time can be shortened. In addition, since the liquid channel is pressurized, it is difficult for air to enter the channel from the outside. In step S101, if it is found that the cam member 64 is located at another position, the motor 61a is driven based on the detection results of the cam sensor 65 and the motor encoder 61b to move the cam member 64 to the closing position.

In step S102, the motor 61a is rotated in the reverse direction. Thus, the cam member 64 rotates in the forward direction and moves from the closing position to the pressure reducing position via the air release A position. When passing through the air release A position, the pressure chamber 20b communicates with the air via the pressure adjusting unit 60. Hence, the air at the positive pressure in the pressure chamber 20b come out at once, and the pressure in the pressure chamber 20b is close to the atmospheric pressure.

Note that in this embodiment, the cam member 64 is caused to only pass through the air release A position without stopping. For example, if the channel is narrow and air cannot easily be discharged, the cam member 64 may temporarily be stopped at the air release A position.

Next, in step S103, it is determined whether the cam member 64 transitions up to the pressure reducing position. Until the transition is completed, driving of the motor 61a is continued. When the transition is completed, in step S104, the rotation direction of the motor 61a is reversed to the forward direction. Thus, the rotation of the cam member 64 stops at the pressure reducing position, and the air pump 61 operates. Air in the pressure chamber 20b is exhausted by the pressure adjusting unit 60, and the pressure in the pressure chamber 20b is reduced. Since the driving of the air pump 61 is continued, the pressure in the pressure chamber 20b is reduced up to a negative pressure value determined by the capability of the air pump 61. In this case, the restricting unit 25 quickly operates to the state ST52 in FIG. 5.

Next, in step S105, how much the liquid Lis replenished from the container 17 to the liquid chamber 20a is monitored based on the detection results of the remaining amount detection sensor 71 and the remaining amount detection sensor 72. If it is confirmed that the remaining amount of the liquid L falls within the region I, the printing apparatus waits to maintain the state for time t1 seconds. This is because it is taken a while until the remaining amount in the liquid chamber 20a reaches the total capacity of 100% because of a restriction on the flow rate. The time t1 is set in advance in consideration of the viscosity of the liquid L or the sectional area or length of the channel from the container 17 to the liquid chamber 20a. After the elapse of time t1 seconds, it is considered that the remaining amount in the liquid chamber 20a reaches the total capacity of 100%.

Note that if the remaining amount in the container 17 is short, the container 17 may be empty after the remaining amount exceeds the threshold Low shown in FIG. 8 and the remaining amount may not reach the total capacity of 100%. Even in this case, it is temporarily considered that replenishment is done up to the total capacity of 100%, and the remaining amount information is corrected based on the detection results of the remaining amount detection sensor 71 and the remaining amount detection sensor 72 in the process of consuming the liquid in the liquid chamber 20a in the supplying operation later.

If it cannot be detected in step S105 that the remaining amount falls within the remaining amount region I, the printing apparatus waits for time t2 seconds in step S106. If the remaining amount does not exceed the threshold Low in FIG. 8 even after the wait for time t2 seconds and it cannot be confirmed that the remaining amount falls within the region I, it is determined that the container 17 is empty and the replenishing operation cannot be completed. In this case, it is preferable to notify the user that the container 17 is empty, and liquid runout flag information is set to ON in step S107. The ON of the flag information is notified to the main control circuit 200, and corresponding processing (notification to the user) is executed by the main control circuit 200.

On the other hand, unless the remaining amount in the liquid chamber 20a falls within the region IV, the printing operation can be continued, and therefore, the process advances to the next step in this state.

Since the replenishing operation itself is thus ended, the rotation of the motor 61a is switched to the reverse direction in step S109 to advance to the supplying operation of the liquid L to the side of the discharge head 11. Thus, the cam member 64 starts rotating in the forward direction again. The cam member 64 moves from the pressure reducing position to the pressurization position via the air release B position. When passing through the air release B position, the pressure chamber 20b communicates with the air via the pressure adjusting unit 60. Hence, air flows at once from the outside into the pressure chamber 20b with a negative pressure, and the pressure in the pressure chamber 20b is close to the atmospheric pressure.

Note that in this embodiment, the cam member 64 is caused to only pass through the air release B position without stopping. For example, if the channel is narrow and air cannot easily flow in, the cam member 64 may temporarily be stopped at the air release B position.

Next, in step S110, it is determined whether the cam member 64 transitions up to the pressurization position. Until the transition is completed, driving of the motor 61a is continued. When the transition is completed, in step S111, the rotation direction of the motor 61a is reversed to the forward direction. Thus, the rotation of the cam member 64 stops at the pressurization position, and the air pump 61 operates. The pressure adjusting unit 60 makes air flow from the outside into the pressure chamber 20b to do pressurization. The maximum pressure in the pressure chamber 20b rises up to a positive pressure value set by the constant pressure valve 63. Since the supply pressure of the liquid to be supplied to the side of the discharge head 11 is determined by the positive pressure value, a value that is as correct as possible is preferably obtained. In this embodiment, the constant pressure valve 63 incorporates a spring, and if the pressure is equal to or more than the spring force, the constant pressure valve 63 discharges air to the outside. Hence, an accurate spring force is used, or the spring force is adjusted if desired.

Next, in step S112, it is determined, based on the detection result of the pressure sensor 73, whether the pressure in the pressure chamber 20b exceeds P1 that is a predetermined pressure (positive pressure). Here, P1 is a pressure a little lower than the opening pressure of the constant pressure valve 63. If the pressure in the pressure chamber 20b exceeds P1, the process advances to the next step. Note that although the pressure sensor 73 is attached in this embodiment, providing the pressure sensor leads to an increase of cost, and to avoid this, a configuration without the pressure sensor 73 is also possible. In this case, time until the pressure sufficiently exceeds the opening pressure of the constant pressure valve 63 is set in consideration of the capability of the air pump 61 and the capacity of the pressure chamber 20b. That is, it may be determined that the pressure reaches the target positive pressure value after the rotation of the motor 61a in the forward direction is started in step S111 and the motor 61a is driven up to the set time.

Next, in step S113, the driving of the motor 61a is temporarily stopped. At this point of time, the pressure chamber 20b is already pressurized to a predetermined positive pressure. That is, the stopper 27 of the restricting unit 25 is retreated, local deformation of the wall member 22 (elastic deformation of the portion A in the state ST61 shown in FIG. 6) is eliminated, and the positive pressure is applied to the wall member 22 to set the supply state of the liquid L. That is, the liquid in the liquid chamber 20a begins to be Although depending on the state from the supplied to the discharge head 11. intermediate tank 20 to the negative pressure maintaining unit 50, if an adequate amount of liquid L flows into the storage portion 50a, the capacity of the liquid chamber 20a is reduced, and the capacity of the pressure chamber 20b increases accordingly. Hence, as a result, the pressure in the pressure chamber 20b lowers. Since the pressure in the pressure chamber 20b may be kept as constant as possible, the pressure state is confirmed in the next step.

Next, in step S114, the detection result of the pressure sensor 73 is confirmed, and it is confirmed whether the pressure in the pressure chamber 20b does not fall below the pressure P1 even after the elapse of preset time t3. If the pressure P1 is maintained even after the elapse of time t3 seconds, it is determined that the liquid amount supplied from the liquid chamber 20a to the side of the discharge head 11 is small, and the process advances to the next step. If the pressure in the pressure chamber 20b falls below the pressure P1 within time t3 seconds, pressurization may be performed again. In step S115, the motor 61a is rotated in the forward direction, and the pressure chamber 20b is re-pressurized. In this case, if the remaining amount in the liquid chamber 20a decreases to the region IV, it is impossible to supply the liquid to the side of the discharge head 11 even by applying a positive pressure. For this reason, in step S116, the remaining amount in the liquid chamber 20a is confirmed. If the remaining amount does not decrease to the region IV, the process returns to step S114. If the remaining amount in the liquid chamber 20a decreases to the region IV, the process returns to step S102 because the replenishing operation to the liquid chamber 20a may be desired.

Next, in step S117, the remaining amount of the liquid L in the liquid chamber 20a after the pressure in the pressure chamber 20b is stabilized (that is, after the liquid supplying operation to the side of the discharge head 11 stops) is confirmed. Here, if the remaining amount falls within the region I, the process advances to the next step. Otherwise, the replenishing operation may be performed again, and the process returns to step S102.

Next, in step S118, the motor 61a is rotated in the reverse direction to start moving the cam member 64 to the closing position. If it is determined in step S119 that the movement of the cam member 64 to the closing position is completed, in step S120, the rotation of the motor 61a is stopped, and the processing is ended.

### Supplying Operation

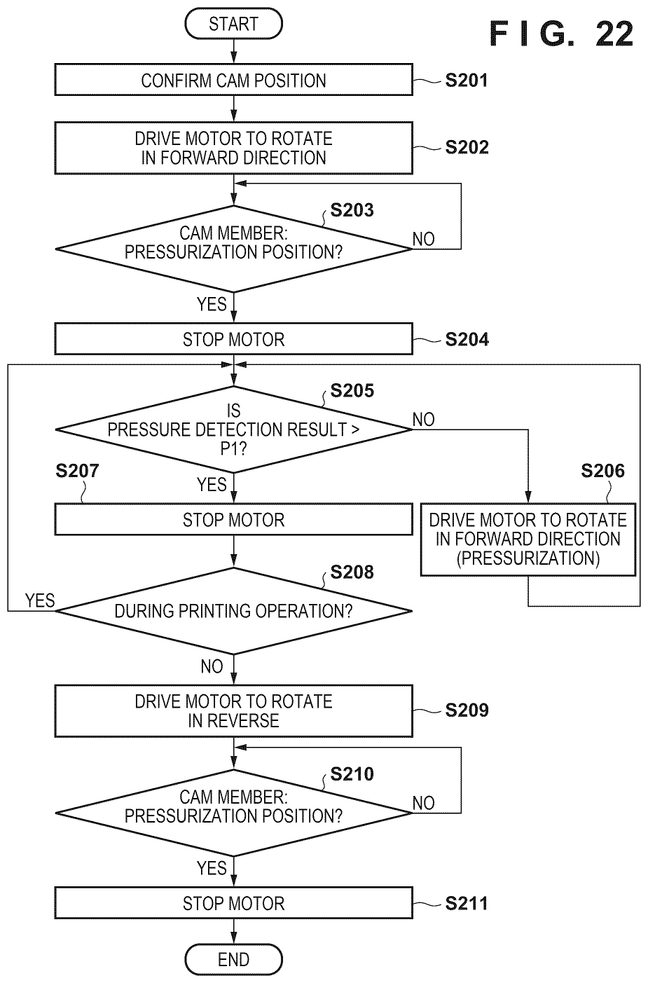

FIG. 22 is a flowchart showing an example of processing of the supplying operation during the printing operation. That is, this is processing concerning control concerning pressure management of the pressure chamber 20b during the printing operation.

At the start of the printing operation, in step S201, it is confirmed that the cam member 64 is located at the closing position. This is the same processing as step S101 shown in FIG. 20. Next, in step S202, the motor 61a is rotated in the forward direction. Here, by the action of the clutch mechanism in the driving gear train 660, the cam member 64 is rotated in the reverse direction by rotating the motor 61a in the forward direction in the section of returning from the closing position to the pressurization position.

Next, in step S203, it is determined whether the cam member 64 transitions to the pressurization position. The driving of the motor 61a is continued until the transition is completed. If the transition is completed, the motor 61a is stopped in step S204. If the cam member 64 is located at the pressurization position, the pressure chamber 20b can be pressurized by rotating the motor 61a in the forward direction.

Next, in step S205, the detection result of the pressure sensor 73 during the printing operation is monitored. If the pressure in the pressure chamber 20b is larger than the pressure P1, in step S207, the motor 61a is kept stopped. If the pressure in the pressure chamber 20b falls below the pressure P1, in step S206, the motor 61a is rotated in the forward direction to start pressurizing the pressure chamber 20b.

As an example of the cause of lowering of the pressure in the pressure chamber 20b, when the liquid L is discharged from the nozzles of the discharge head 11, the remaining amount in the liquid chamber 20a decreases. Also, if the wait time in which the printing operation is not executed is long, a small amount of air may leak from somewhere in the closing portion of the pressure chamber 20b and the pressure may lower. In this case, the pressure chamber 20b is pressurized again up to a desirable pressure for the supplying operation. The process returns to step S205, and if the pressure in the pressure chamber 20b is larger than the pressure P1, in step S207, the motor 61a is stopped to end re-pressurization.

Next, in step S208, it is determined, by communication with the main control circuit 200, whether the printing operation is continued. If the printing operation is continued, the process returns to step S205 to continuously monitor the pressure in the pressure chamber 20b. If the printing operation is ended, the process advances to step S209, and the motor 61a is rotated in the reverse direction to make the cam member 64 transition to the closing position.

Next, in step S210, it is determined whether the cam member 64 transitions to the closing position. Until the transition is completed, the driving of the motor 61a is continued. If the transition is completed, the motor 61a is stopped in step S211. Thus, control of the supplying operation during the printing operation is ended.

### Remaining Amount Detection

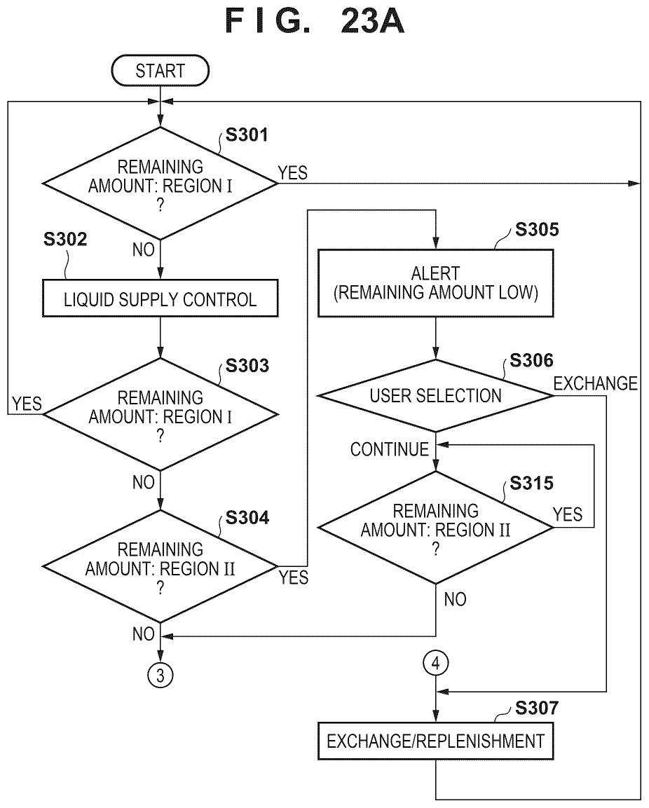

FIGS. 23A and 23B show a flowchart showing an example of processing concerning remaining amount detection of the liquid chamber 20a during the printing operation. Processing shown in FIGS. 23A and 23B is appropriately executed together with the processing shown in FIG. 22. At the same time as the start of the printing operation, the remaining amount in the liquid chamber 20a is monitored while monitoring the detection results of the remaining amount detection sensor 71 and the remaining amount detection sensor 72.

In step S301, if the remaining amount falls within the region I (FIG. 8), remaining amount monitoring is continued. If the remaining amount falls below the threshold Low (FIG. 8), the process advances to the next step. In step S302, the replenishing operation is executed. Processing concerning the replenishing operation is the same as described with reference to FIGS. 20 and 21. Note that the replenishing operation during the printing operation is performed at timing set not to cause stop of the printing operation or lowering of throughput.

Next, in step S303, the remaining amount in the liquid chamber 20a after the replenishing operation is confirmed. If the remaining amount exceeds the threshold Low (FIG. 8) and falls within the region I (FIG. 8), the process returns to step S301 again to continue monitoring of the remaining amount. If the remaining amount falls below the threshold Low (FIG. 8), the process advances to the next step to confirm the region that the remaining amount falls within and perform corresponding processing.

In step S304, it is determined whether the remaining amount in the liquid chamber 20a falls within the region II (FIG. 8). If the remaining amount does not fall within the region II, the process advances to step S308. If the remaining amount falls within the region II, the process advances to step S305. Here, if the remaining amount does not exceed the threshold Low (FIG. 8) even after the replenishing operation in step S302, it is determined that the container 17 is empty, and the flag is turned on in step S107 in FIG. 20. However, since the printing operation can still be continued in this state, if the printing operation is being performed, it is never interrupted for the replenishing operation. For this reason, if it is determined in step S304 that the remaining amount falls within the region II, in step S305, a warning indicating that the remaining amount is small is notified to the main control circuit 200. The main control circuit 200 can make a notification such as warning display to the user using, for example, the operation unit 14.

In step S306, processing branches depending on the action of the user to the warning. The user can select an action via, for example, the operation unit 14. If the user selects exchange of the container 17, the process advances to step S307, and the exchange work of the container 17 by the user and processing of the subsequent replenishing operation shown in FIGS. 20 and 21 are performed. Since the remaining amount is recovered to the region I (FIG. 8) by the replenishing operation, the process then returns to step S301. On the other hand, if the user determines that exchange of the container 17 is not needed at that point of time and selects to continue the printing operation, the process advances to step S315, and it is determined whether the remaining amount falls within the region II. The processing of step S315 is repeated until the remaining amount does not fall within the region II anymore. If it is determined that the remaining amount does not fall within the region II anymore, the process advances to step S308.

Next, in step S308, it is determined whether the remaining amount in the liquid chamber 20a falls within the region III (FIG. 8). If the remaining amount does not fall within the region III (FIG. 8), it can be determined that the remaining amount already falls within the region IV (FIG. 8), and in this case, the process advances to step S313 to be described later. If the remaining amount falls within the region III (FIG. 8), in step S309, a warning indicating that there is no liquid anymore is notified to the main control circuit 200. In step S310, the main control circuit 200 can temporarily stop the printing operation at appropriate timing and make a notification by displaying a warning to promote the user to exchange the container 17.

Next, in step S311, processing branches depending on the action of the user to the warning. The user can select an action via, for example, the operation unit 14. The user can select whether to exchange the container 17 at once or continue the printing operation, knowing that there is little liquid remains. If the user selects exchange of the container 17, the process advances to step S307, and the exchange work of the container 17 by the user and processing of the subsequent replenishing operation shown in FIGS. 20 and 21 are performed. If the user selects to continue the printing operation, the process advances to step S312.

In step S312, it is determined whether the remaining amount in the liquid chamber 20a falls within the region IV (FIG. 8). If the remaining amount does not fall within the region IV (FIG. 8), the printing operation is still possible, and the printing operation is continued. If the remaining amount falls within the region IV (FIG. 8), the printing operation cannot be continued, and the process advances to step S313.

In step S313, a warning indicating that there is no liquid amount anymore in the liquid chamber 20a is notified to the main control circuit 200. Using, for example, the operation unit 14, the main control circuit 200 can make, to the user, a notification such as warning display indicating that the printing operation cannot be continued. Then, in step S314, the printing operation is stopped, and the processing waits until the user exchanges the container 17.

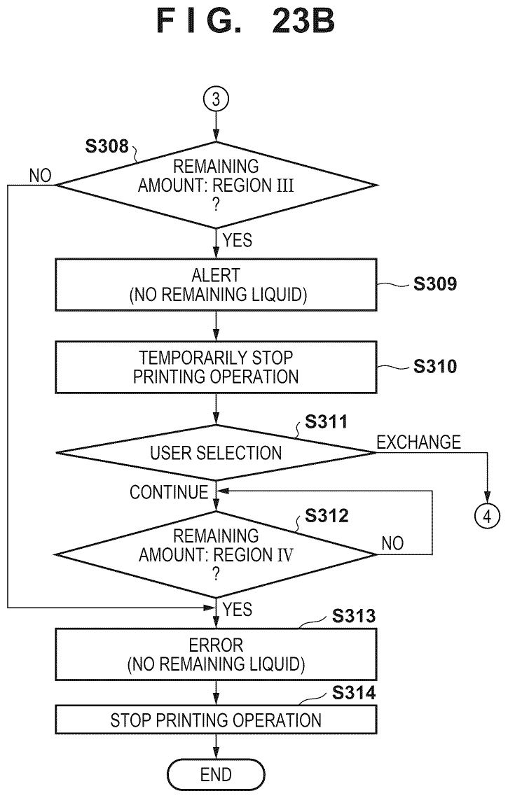

Next, remaining amount detection control that is performed when the printing apparatus 1 is powered on or when wait is ended to confirm the remaining amount in the liquid chamber 20a after long time wait will be described. FIG. 24 is a flowchart. As a prerequisite of control, when the printing apparatus 1 is powered off or before a long-time wait state is started, region information indicating the region (FIG. 8) that the remaining amount in the liquid chamber 20a falls within is stored as remaining amount information in the RAM 102.

In step S401, region information Roff is read out from the RAM 102. Next, in step S402, current region information Ron is determined based on the detection results of the remaining amount detection sensor 71 and the remaining amount detection sensor 72. Next, in step S403, it is confirmed whether regions indicated by the region information Roff and the region information Ron match. If the regions match, a normal activation operation is started. After that, when powering off the printing apparatus 1 or starting the long-time wait state, in step S404, the region information Roff at that time is stored in the RAM 102.

If the region information Roff and the region information Ron do not match in step S403, the remaining amount in the liquid chamber 20a has changed during wait. Particularly, if the region indicated by the region information Ron is a region where the remaining amount of the liquid L is small as compared to the region information Roff, it is estimated that unintended liquid flow-out has occurred. Since a failure may occur somewhere in the supplying unit 18, error processing is performed in step S405. Here, for example, liquid leakage occurrence error information is notified to the main control circuit 200. The main control circuit 200 can take a measure not to continue the printing operation after then and notify the user of the failure using the operation unit 14.

### Summary

According to the air release unit 80 of this embodiment, even if the exchange-associated operation is performed during the supplying operation in which the pressure chamber 20b is set in the positive pressure state, the positive pressure state in the pressure chamber 20b is maintained. With this action, the pressure chamber 20b keeps the positive pressure state independently of the exchange-associated operation. Hence, the supplying operation can be continued, and it is possible to immediately perform the supplying operation of the liquid upon receiving the next printing operation instruction. Also, since the channel from the intermediate tank 20 to the limiting valve 54 on the downstream side is continuously pressurized, the phenomenon that air enters into the channel can be suppressed.

On the other hand, if the exchange-associated operation is performed during the replenishing operation in which the pressure chamber 20b is set in the negative pressure state, the pressure chamber 20b is adjusted such that it quickly returns to the atmospheric pressure. With this action, even if the container 17 is carelessly removed from the storage unit 15A (or the storage unit 15B) during the liquid replenishing operation, an effect of suppressing entering of air from the joint portion into the channel can be obtained.

Also, since the restricting unit 25 is provided, even immediately after the replenishing operation from the container 17 to the intermediate tank 20 is executed, an effect of reducing variations of the supply pressure of the liquid L from the intermediate tank 20 to the discharge head 11 can be obtained. As a consequence, the discharging operation from the discharge nozzles of the discharge head 11 is stable.

Also, since the wall member 22 or the flexible member 26 is formed into a diaphragm shape of a flexible material, a mechanism capable of varying the capacity with a simple configuration can be formed, and it is therefore possible to obtain an effect of reducing the size of the apparatus and suppressing apparatus cost.

Also, in the pressure adjusting unit 60, the four control valves 62A to 62D are independently driven, and the closing position and the air release positions are provided at the cam positions. Hence, during wait, the pressure chamber 20b can be maintained in the pressurized state. In addition, it is possible to obtain an effect of shortening time when varying the pressure chamber 20b from positive pressure->negative pressure or from negative pressure→positive pressure.

Also, in the pressure adjusting unit 60, since the valve rubber 622 is integrally formed as a component shared by the control valves 62A to 62D, it is possible to obtain the effect of reducing the size of the apparatus and suppressing apparatus cost. Furthermore, since even the function of the constant pressure valve 63 is integrated into the valve rubber 622, it is possible to expect the effect of further reducing the size of the apparatus and suppressing apparatus cost.

Also, since the detection lever 70 always abuts against the abutment member 24 that moves integrally with the wall member 22 and the swing state of the detection piece 70c is detected by the remaining amount detection sensors 71 and 72, the remaining amount in the liquid chamber 20a can be detected. When the dot count is used together, a more specific remaining amount can be detected. Furthermore, when the remaining amount in the liquid chamber 20a is detected, it is possible to detect that no liquid remains anymore in the container 17 without providing, in the container 17, a sensor that detects the remaining amount.

Also, since the apparatus is configured to detect whether the remaining amount in the liquid chamber 20a does not largely change before and after the wait period in which the printing operation is not performed for a long time, unintended liquid leakage can be detected, and an effect of improving reliability can be obtained.

### Second Embodiment

In the first embodiment, as the exchange-associated operation, the operation of opening the access cover 16A or 16B has been exemplified. However, the exchange-associated operation may be another operation. For example, in a configuration in which the cover of the top portion of the printing apparatus is opened to exchange a container, the exchange-associated operation may be an operation of opening the cover to the top portion. Alternatively, the exchange-associated operation may be an operation itself of extracting a container 17 from a storage unit 15A or 15B. Alternatively, in a configuration in which the container 17 can be exchanged when the user instructs, on the operation unit, to exchange the container 17, the exchange-associated operation may be an exchange operation to the operation unit. In this case, for example, a configuration according to the third embodiment to be described later may be employed.

### Third Embodiment

A sensor configured to detect the exchange-associated operation may be provided, and processing based on the detection result may be performed.

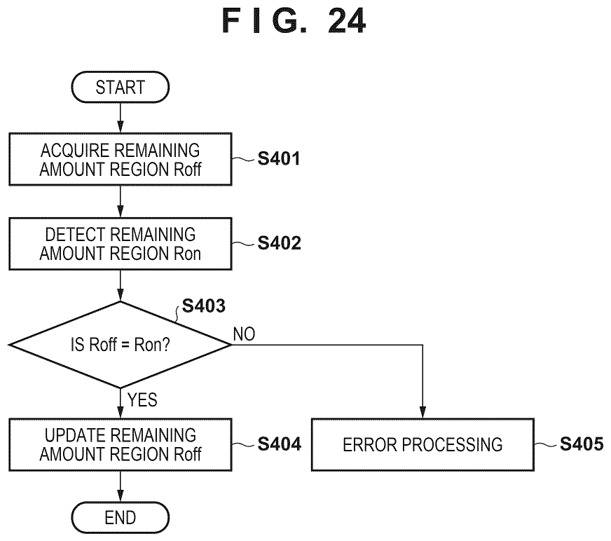

FIG. 25 is a block diagram of a control circuit 100 according to this embodiment. Points different from the example shown in FIG. 19 will be described. A printing apparatus 1 includes cover sensors 74A and 74B that are sensors configured to detect the exchange-associated operation, and the control circuit 100 can acquire the detection results of these sensors. The cover sensor 74A is a sensor that detects the open/closed state of an access cover 16A, and the cover sensor 74B is a sensor that detects the open/closed state of an access cover 16B. The cover sensors 74A and 74B are, for example, optical sensors and are each arranged to be ON when the corresponding cover is in the open state and OFF in the closed state.

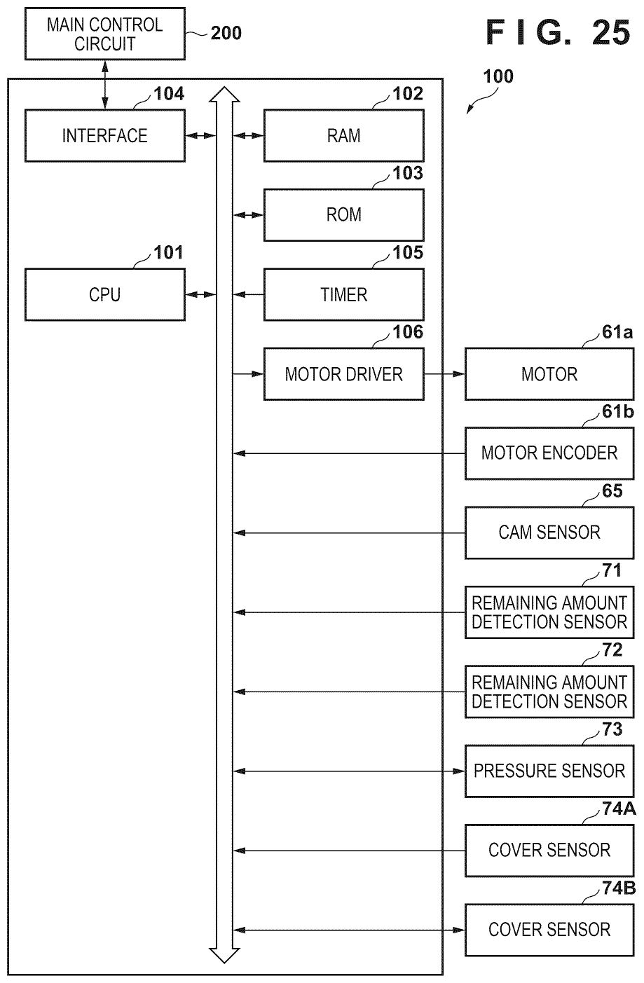

FIG. 26 is a flowchart showing an example of processing executed by a CPU 101 of the control circuit 100, which is access cover monitoring processing during the replenishing operation. In the negative pressure state of a pressure chamber 20b, if the pressure chamber 20b is returned to the atmospheric pressure by an air release unit 80, suction of a liquid L from a container 17 to a liquid chamber 20a ends. Along with this, in this embodiment, processing of interrupting a series of replenishing operations and making a necessary notification to the user is performed.

Processing shown in FIG. 26 is started in parallel to the replenishing operation shown in FIGS. 20 and 21 and executed in parallel. In step S501, the detection results of the cover sensors 74A and 74B are acquired, and it is determined whether both the access cover 16A and the access cover 16B are in the closed state. Upon determining that both the access cover 16A and the access cover 16B are in the closed state, the process advances to step S502. Upon determining that at least one of the access cover 16A and the access cover 16B is in the open state, the process advances to step S503.

In step S502, it is determined whether the replenishing operation is ended. If the replenishing operation is ended, the processing is ended. If the replenishing operation is not ended, the process returns to step S501. Thus, as long as both the access covers 16A and 16B are in the closed state during the replenishing operation, monitoring of the access covers 16A and 16B is continued by a processing loop formed by steps S501 and S502.

In step S503, the replenishing operation is interrupted. More specifically, regardless of which step in FIGS. 20 and 21 processed in parallel to the processing shown in FIG. 26 is being executed, a motor 61a is forcibly stopped, thereby ending the processing. In step S504, a warning indicating that replenishment is interrupted because the access cover 16A or the access cover 16B is opened is notified to a main control circuit 200. The main control circuit 200 can make a notification such as warning display to the user using, for example, an operation unit 14. Note that this notification may be executed by sound or light (warning light) for notifying the warning.

Note that in this embodiment, the start and end of the monitoring processing shown in FIG. 26 are performed in synchronism with the start and end of the replenishing operation. Definitely detecting opening of the access covers 16A and 16B in the negative pressure state of the pressure chamber 20b suffices. For example, the monitoring section may be limited by setting the start timing of the processing shown in FIG. 26 at the same timing as the start of step S104 in FIG. 20 and performing the determination of step S502 depending on whether step S109 in FIG. 20 is ended. Alternatively, the monitoring section may be limited by performing the determination of step S501 using an additional condition that the pressure detected by a pressure sensor 73 is a negative pressure.

### Fourth Embodiment

In the first embodiment, as the configuration of the air release unit 80, the pressure chamber 20b is mechanically released to air in accordance with the exchange-associated operation. However, the pressure chamber 20b may be released to air by control. For example, the interlocking valve 82 may be changed to an electronic control valve, and a sensor configured to detect the exchange-associated operation may be provided such that when the sensor detects the exchange-associated operation, the electronic control valve is opened.

Alternatively, no air release unit 80 is provided, and when the exchange-associated operation is detected by a sensor that detects the exchange-associated operation, air release may be performed by a pressure adjusting unit 60 at an air release A position.

That is, the pressure adjusting unit 60 may function as a unit configured to perform air release. Control will be described below. In this embodiment, cover sensors 74A and 74B are provided, like the example shown in FIG. 25.

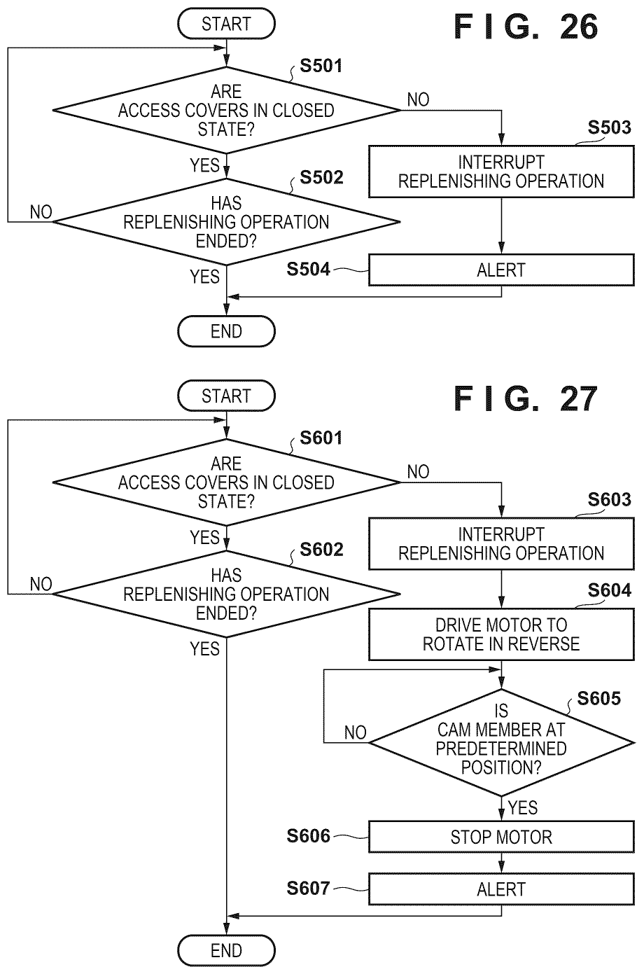

FIG. 27 is a flowchart showing an example of processing executed by a CPU 101 of a control circuit 100, which shows an example of processing of access cover monitoring and an air release operation at the time of opening the access cover. Processing shown in FIG. 27 is started at the same time as the replenishing operation shown in FIGS. 20 and 21 and executed in parallel.

Steps S601, S602, and S603 are the same as steps S501, S502, and S503 in FIG. 26, respectively. The closed states of access covers 16A and 16B are monitored, and if opening of the access cover 16A or the access cover 16B is detected, the replenishing operation is interrupted.

In step S604, a motor 61a is rotated in the reverse direction to start moving a cam member 64 to an air release A position. If it is determined in step S605 that the movement of the cam member 64 to the air release A position is completed, the rotation of the motor 61a is stopped in step S606. The pressure chamber 20b is thus released to air. Step S607 is the same processing as step S504 in FIG. 26. If the access cover 16A or the access cover 16B is opened, a warning indicating that replenishment is interrupted is notified to a main control circuit 200.

Note that a configuration that completes air release in a shorter time may be formed by providing the air release unit 80 and performing air release by the pressure adjusting unit 60, as described above.

### Fifth Embodiment

In the first embodiment, the restricting unit 25 is provided. However, a configuration without the restricting unit 25 may also be employed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2024-112649, filed Jul. 12, 2024, and No. 2025-069899, filed Apr. 21, 2025, which are hereby incorporated by reference herein in their entirety.

What is claimed is:

1. A printing apparatus comprising:
a forming unit configured to form a liquid chamber to which a liquid is introduced from a liquid container and which stores the liquid to be supplied to a discharging unit configured to discharge the liquid to a print medium, and a pressure chamber adjacent to the liquid chamber;
a wall member configured to partition between the liquid chamber and the pressure chamber and be displaced in accordance with a pressure in the pressure chamber so as to change a capacity of the liquid chamber;
a pressure adjusting unit configured to adjust the pressure in the pressure chamber so as to perform a replenishing operation of introducing the liquid from the liquid container to the liquid chamber, and a supplying operation of supplying the liquid from the liquid chamber to the discharging unit; and
an air release unit configured to release the pressure chamber to air in accordance with an operation associated with exchange of the liquid container during the replenishing operation but not to release the pressure chamber to the air for the operation during the supplying operation.

2. The apparatus according to claim 1, wherein
the air release unit includes:
a differential pressure valve configured to, by a differential pressure between a first passage communicating with the pressure chamber and a second passage, switch communication and cutoff between the first passage and the second passage; and
an interlocking valve configured to, interlocking with the operation, switch a third passage communicating with the second passage from a state in which the third passage is closed against the air to a state in which the third passage is released to the air.

3. The apparatus according to claim 1, wherein
the wall member is displaced to increase the capacity of the liquid chamber when the pressure chamber is set in a negative pressure state, and
the pressure adjusting unit
adjusts the pressure chamber to the negative pressure state in the replenishing operation to introduce the liquid from the liquid container to the liquid chamber, and
adjusts the pressure chamber to a positive pressure state in the supplying operation to supply the liquid from the liquid chamber to the discharging unit.

4. The apparatus according to claim 3, wherein
the air release unit includes:
a differential pressure valve configured to, by a differential pressure between a first passage communicating with the pressure chamber and a second passage, switch communication and cutoff between the first passage and the second passage; and
an interlocking valve configured to, interlocking with the operation, switch a third passage communicating with the second passage from a state in which the third passage is closed against the air to a state in which the third passage is released to the air, and
the differential pressure valve makes the first passage and the second passage communicate with each other in a case where a pressure in the first passage is lower than that in the second passage.

5. The apparatus according to claim 1, further comprising an access cover configured to open/close a storage unit of the liquid container,
wherein the operation is an operation of opening the access cover.

6. The apparatus according to claim 2, wherein
the pressure adjusting unit includes:
a pump; and
a plurality of control valves provided between the pump and the pressure chamber,
an operation of pressurizing the pressure chamber by the pump and an operation of reducing the pressure in the pressure chamber are performed by combining opening/closing of the plurality of control valves, and
some parts of the differential pressure valve and the plurality of control valves are integrated.

7. A printing apparatus comprising:
a forming unit configured to form a liquid chamber to which a liquid is introduced from a liquid container and which stores the liquid to be supplied to a discharging unit configured to discharge the liquid to a print medium, and a pressure chamber adjacent to the liquid chamber;
a wall member configured to partition between the liquid chamber and the pressure chamber and be displaced in accordance with a pressure in the pressure chamber, thereby changing a capacity of the liquid chamber;
a pressure adjusting unit configured to adjust the pressure in the pressure chamber; and
an air release unit configured to switch whether to release the pressure chamber to air or not,
wherein the wall member is displaced to increase the capacity of the liquid chamber when the pressure chamber is set in a negative pressure state, and
the air release unit releases the pressure chamber to the air in accordance with an operation associated with exchange of the liquid container in a negative pressure state of the pressure chamber but does not release the pressure chamber to the air for the operation in a positive pressure state of the pressure chamber.

8. The apparatus according to claim 7, wherein
the pressure adjusting unit includes:
a pump; and
a plurality of control valves provided between the pump and the pressure chamber, and
an operation of pressurizing the pressure chamber by the pump, an operation of reducing the pressure in the pressure chamber, and an operation of releasing the air release unit to the air are performed by combining opening/closing of the plurality of control valves.

9. The apparatus according to claim 1, further comprising a control unit configured to interrupt the replenishing operation in accordance with the operation associated with exchange of the liquid container during the replenishing operation.

10. The apparatus according to claim 9, wherein
in a case where the replenishing operation is interrupted, the control unit performs processing concerning a warning to a user.
